(19) United States
(12) Patent Application Publication
(10) Pub. No.: US 2025/0079767 A1
(43) Pub. Date: Mar. 6, 2025

(54) HYBRID CONNECTOR AND CONNECTION STRUCTURE OF HYBRID CONNECTORS INCLUDING THE SAME

(71) Applicant: HOSIDEN CORPORATION, Osaka (JP)

(72) Inventor: Yuta IWAMOTO, Yao-Shi (JP)

(73) Assignee: HOSIDEN CORPORATION, Osaka (JP)

(21) Appl. No.: 18/767,530

(22) Filed: Jul. 9, 2024

(30) Foreign Application Priority Data
Sep. 5, 2023 (JP) 2023-143899

(51) Int. Cl. H01R 13/64; H01R 13/518; H01R 13/627

(52) U.S. Cl. CPC H01R 13/64; H01R 13/518; H01R 13/6272

(57) ABSTRACT

A hybrid connector including a housing constituted by an insulating material, a first connecting portion protruding from the housing to one side in a first direction, at least one first terminal inside the first connecting portion, a second connecting portion protruding from the housing to the one side in the first direction and being disposed on one side in a second direction relative to and in spaced relation to the first connecting portion, at least one second terminal inside the second connecting portion, and at least one anti-misinsertion projection provided at the second connecting portion such as to project to the other side in the second direction and disposed between the first and second connecting portions in the second direction. The second direction is substantially orthogonal to the first direction.

### CROSS-REFERENCE TO RELATED APPLICATION

The present application claims priority under 35 U.S.C. § 119 of Japanese Patent Application No. 2023-143899 filed on Sep. 5, 2023, the disclosure of which is expressly incorporated by reference herein in its entirety.

### BACKGROUND OF THE INVENTION

### Technical Field

The invention relates to hybrid connectors and connection structures of hybrid connectors including the same.

### Background Art

JP2014-107139A describes a conventional connection structure of hybrid connectors. The connection structure includes a first hybrid connector and a second hybrid connector.

The first hybrid connector includes a housing, two tubular first outer conductors, two first inner conductors, two first insulators, two tubular second outer conductors, two second inner conductors, two second insulators, and a power line. The housing includes a body portion, a protruding portion protruding from the body portion to one side in a first direction, and first and second anti-misinsertion projections extending from the protruding portion to one side and the other side, respectively, in a second direction. The first anti-misinsertion projection is located on one side in a third direction relative to the second anti-misinsertion projection. The second direction is substantially orthogonal to the first direction, and the third direction is substantially orthogonal to the first and second directions. The body portion and the protruding portion are provided with two first housing spaces, two second housing spaces, and a third housing space. The protruding portion is provided with two first openings, two second openings, and a third opening. The two first openings communicate with the respective two first housing spaces and open to the one side in the first direction. The two second openings communicate with the respective two second housing spaces and open to the one side in the first direction. The third opening communicates with the third housing space and opens to the one side in the first direction. The two first outer conductors are housed in the respective two first housing spaces of the housing and are exposed from the respective two first openings of the protruding portion. The two first inner conductors are retained by the respective two first insulators. The two first insulators are retained in the respective two first outer conductors, together with the two first inner conductors. The two second outer conductors are housed in the respective two second housing spaces of the housing and are exposed from the respective two second openings of the protruding portion. The two second inner conductors are retained by the two second insulators. The two second insulators are retained in the two second outer conductors, together with the two second inner conductors. The power line is housed in the third housing portion of the housing and exposed from the third opening of the protruding portion.

The second hybrid connector includes a housing, two tubular first outer conductors, two first inner conductors, two first insulators, two tubular second outer conductors, two second inner conductors, two second insulators, and a power terminal. The housing of the second hybrid connector includes a fitting recess to fittingly receive the protruding portion of the first hybrid connector, and first and second anti-misinsertion recesses being respectively provided at one and the other walls in the second direction of the fitting recess and having respective outer shapes, sizes, and positions corresponding to those of the first and second anti-misinsertion projections of the first hybrid connector. The two first outer conductors of the second hybrid connector are retained by the housing of the second hybrid connector and have distal portions protruding into the fitting recess. The two first inner conductors of the second hybrid connector are retained by the respective two first insulators of the second hybrid connector. The two first insulators of the second hybrid connector are retained in the respective two first outer conductors of the second hybrid connector, together with the two first inner conductors of the second hybrid connector. The two second outer conductors of the second hybrid connector are retained by the housing of the second hybrid connector and have distal portions protruding into the fitting recess. The two second inner conductors of the second hybrid connector are retained by the two second insulators of the second hybrid connector. The two second insulators of the second hybrid connector are retained in the respective two second outer conductors of the second hybrid connector, together with the two second inner conductors of the second hybrid connector. The power terminal is retained by the housing and has a distal portion protruding into the fitting recess.

The first and second anti-misinsertion projections of the first hybrid connector are fitted in the first and second anti-misinsertion recesses, respectively, of the second hybrid connector, and the protruding portion of the first hybrid connector is fitted in the fitting recess of the second hybrid connector, so that the two first outer conductors, the two first inner conductors, the two second outer conductors, and the two second inner conductors of the first hybrid connector are respectively connected to the two first outer conductors, the two first inner conductors, the two second outer conductors, and the two second inner conductors of the second hybrid connector, and the power terminal of the second hybrid connector is connected to the power line of the first hybrid connector.

### SUMMARY OF INVENTION

The invention provides a novel hybrid connector having an anti-misinsertion projection and a connection structure of hybrid connectors including the same.

A hybrid connector of an aspect of the invention includes a housing constituted by an insulating material, a first connecting portion, at least one first terminal, a second connecting portion, at least one second terminal, and at least one anti-misinsertion projection. The first connecting portion protrudes from the housing to one side in a first direction. The at least one first terminal is disposed inside the first connecting portion. The or each first terminal includes a first contact portion being disposed such as to be viewable from outside the first connecting portion. The second connecting portion protrudes from the housing to the one side in the first direction and is disposed on one side in a second direction relative to, and in spaced relation to, the first connecting portion. The second direction is substantially orthogonal to the first direction. The at least one second terminal is disposed inside the second connecting portion. The or each second terminal includes a second contact portion being disposed such as to be viewable from outside the second connecting portion. The at least one anti-misinsertion projection is provided at the second connecting portion such as to project to the other side in the second direction. The at least one anti-misinsertion projection is disposed between the first connecting portion and the second connecting portion in the second direction. The first direction is a direction in which the first connecting portion projects.

The hybrid connector of this aspect is configured such that the second connecting portion is disposed on the one side in the second direction relative to, and in spaced relation to, the first connecting portion, such that the at least one anti-misinsertion projection is provided at the second connecting portion such as to project to the other side in the second direction, and such that the at least one anti-misinsertion projection is disposed between the first connecting portion and the second connecting portion in the second direction. Such configurations provide a novel hybrid connector including the at least one anti-misinsertion projection.

The housing may include a body portion and may further include a tube. The body portion may include a first body portion and a second body portion. The tube may have a generally circular tubular shape, a generally polygonal tubular shape, a generally circular tubular shape that is partly cut away, or a generally polygonal tubular shape that is partly cut away. The tube may extend from the first body portion to the one side in the first direction.

The first connecting portion may have electrical conductivity, be of a tubular shape extending in the first direction, and include a protruding portion and a retainable portion. The retainable portion of the first connecting portion may be securely received in the tube or may be retained by the first body portion of the housing. The protruding portion of the first connecting portion may protrude from the tube or the first body portion of the housing to the one side in the first direction.

The hybrid connector may further include a body constituted by an insulating material, the body retaining the at least one first terminal in part. The body may be securely housed in the first connecting portion.

The second connecting portion may be constituted by an insulating material, protrude from the second body portion of the housing to the one side in the first direction, and retain the at least one second terminal. The second connecting portion may include at least one terminal housing portion to house the second contact portion of the or each second terminal.

The first contact portion of the or each first terminal may be disposed inside the first connecting portion and exposed from inside of the first connecting portion such as to be viewable from the one side in the first direction relative to the first connecting portion. The second contact portion of the at least one second terminal may be disposed in the second connecting portion and exposed from inside of the second connecting portion such as to be viewable from the one side in the first direction relative to the second connecting portion.

The at least one anti-misinsertion projection may, but is not required, be constituted by an insulating material and integral and contiguous with the second connecting portion.

The protruding portion of the first connecting portion and/or the tube may include a first portion, which is located on the one side in the second direction relative to a central axis of the first connecting portion, and at least one second portion, which is located on one side or the other side in a third direction relative to the first portion and located on the other side in the second direction relative to the first portion. The third direction may be substantially orthogonal to the first and second directions.

A linear distance in the second direction between the or each second portion of the protruding portion and/or the tube and the second connecting portion may be larger than a linear distance in the second direction between the first portion and the second connecting portion. The or each anti-misinsertion projection may project toward the or a corresponding second portion of the first connecting portion.

The hybrid connector of any of the above aspects may further include a retainer constituted by an insulating material. The second connecting portion may include a pair of engaging holes provided on one side and the other side, respectively, in the third direction relative to the at least one terminal housing portion. The retainer may include a pair of engaging arms, and the engaging arms of the retainer may be hooked to the respective engaging holes. The at least one second terminal may be retained by the retainer and the second connecting portion.

The hybrid connector according to may further include a lock portion. The lock portion may include a proximal portion, an arm, and a lock projection. The proximal portion may rise from a distal portion on the one side in the first direction of the second connecting portion to the one side in the second direction. The arm may extend from the proximal portion to the other side in the first direction and is disposed on the one side in the second direction relative to, and in spaced relation to, the second connecting portion. The arm may, but is not required to, extend to the other side in the first direction beyond an end face on the one side in the first direction of the first body portion. The lock projection may be provided at the arm such as to project to the one side in the second direction. The lock portion may have a dimension in the first direction that is equal to, or smaller than, a sum of a dimension in the first direction of the second connecting portion and a dimension in the first direction of the second body portion of the housing.

A connection structure of hybrid connectors of an aspect of the invention includes a first hybrid connector, which is the hybrid connector of an aspect described above; and a second hybrid connector.

The second hybrid connector may include a shell having electrical conductivity, a body constituted by an insulating material, at least one first terminal, and at least one second terminal.

The shell of the second hybrid connector may include a first connecting hole, a second connecting hole, a bounding wall, at least one anti-misinsertion recess, and a housing hole. The first connecting hole may extend in the first direction and open to other side in the first direction. The second connecting hole may extend in the first direction, open to the other side in the first direction, and be disposed on the one side in the second direction relative to, and in spaced relation to, the first connecting hole. The bounding wall may be a wall between the first connecting hole and the second connecting hole. The at least one anti-misinsertion recess may be provided in the bounding wall, extend from the second connecting hole to the other side in the second direction, open to the other side in the first direction, and communicate with the second connecting hole. The housing hole may be provided on the one side in the first direction relative to the first and second connecting holes, communicate with the first and second connecting holes, and open to the one side in the first direction.

The body of the second hybrid connector may be securely housed in the housing hole. The at least one first terminal of the second hybrid connector may be retained by the body of the second hybrid connector and include a first contact portion protruding from the body into the first connecting hole. The at least one second terminal of the second hybrid connector may be retained by the body of the second hybrid connector and include a second contact portion protruding from the body into the second connecting hole.

The first connecting portion and the second connecting portion of the first hybrid connector may be received in the first connecting hole and the second connecting hole, respectively, of the second hybrid connector, the or each anti-misinsertion projection of the first hybrid connector may be received in the or a corresponding anti-misinsertion recess of the second hybrid connector, and the bounding wall of the second hybrid connector may be received between the first connecting portion and the second connecting portion, the first contact portion of the or each first terminal of the first hybrid connector may be in contact with the first contact portion of the or a corresponding first terminal of the second hybrid connector, and the second contact portion of the or each second terminal of the first hybrid connector may be in contact with the second contact portion of the or a corresponding second terminal of the second hybrid connector.

The shell of the second hybrid connector may include the bounding wall, a first wall, a second wall, and a third wall. The bounding wall, the first wall, the second wall, and the third wall may define the first connecting hole. The first wall may be located on the one side in the third direction relative to the first connecting hole. The second wall may be located on the other side in the third direction relative to the first connecting hole. The third wall may be located on the other side in the second direction relative to the first connecting hole.

The connection structure may be configured such that, in a state where the first connecting portion and the second connecting portion of the first hybrid connector face the first connecting hole and the second connecting hole of the second hybrid connector, respectively, in the first direction, the or each anti-misinsertion projection of the first hybrid connector faces the or a corresponding anti-misinsertion recess of the second hybrid connector in the first direction, and the bounding wall of the second hybrid connector faces the gap of the first hybrid connector in the first direction, by bringing the first hybrid connector and the second hybrid connector relatively close to each other in the first direction, the first connecting portion and the second connecting portion of the first hybrid connector are received into the first connecting hole and the second connecting hole, respectively, of the second hybrid connector, the or each anti-misinsertion projection of the first hybrid connector is received into the or a corresponding anti-misinsertion recess of the second hybrid connector, and the bounding wall of the shell of the second hybrid connector is received into the gap of the first hybrid connector.

The connection structure may be configured such that, in a state where the first connecting portion of the first hybrid connector faces the first connecting hole of the second hybrid connector in the first direction, and the gap of the first hybrid connector faces the first wall, the second wall, or the third wall of the shell of the second hybrid connector in the first direction, by bringing the first hybrid connector and the second hybrid connector relatively close to each other in the first direction, the at least one anti-misinsertion projection and/or the first connecting portion of the first hybrid connector is brought into abutment with the first wall, the second wall, or the third wall of the shell of the second hybrid connector.

The shell of the second hybrid connector may further includes at least one step. The at least one step may be provided at at least one of the bounding wall, the first wall, the second wall, or the third wall and located inside the first connecting hole.

The connection structure may be configured such that, in a state where the first connecting portion of the first hybrid connector faces the first connecting hole of the second hybrid connector in the first direction, and the gap of the first hybrid connector faces the first wall, the second wall, or the third wall of the shell of the second hybrid connector in the first direction, by bringing the first hybrid connector and the second hybrid connector relatively close to each other in the first direction, the first connecting portion of the first hybrid connector is partly received into the first connecting hole of the second hybrid connector, the first wall, the second wall, or the third wall of the shell of the second hybrid connector is partly received into the gap of the first hybrid connector, and the first connecting portion of the first hybrid connector is brought into abutment with the at least one step in the first connecting hole of the second hybrid connector.

The shell of the second hybrid connector may include the bounding wall, a fourth wall, a fifth wall, and a sixth wall. The bounding wall, the fourth wall, the fifth wall, and the sixth wall may define the second connecting hole. The fourth wall may be located on the one side in the third direction relative to the second connecting hole. The fifth wall may be located on the other side in the third direction relative to the second connecting hole. The sixth wall may be located on the one side in the second direction relative to the second connecting hole.

The connection structure may be configured such that, in a state where the second connecting portion of the first hybrid connector faces the second connecting hole of the second hybrid connector in the first direction, and the gap of the first hybrid connector faces the fourth wall, the fifth wall, or the sixth wall of the shell of the second hybrid connector in the first direction, by bringing the first hybrid connector and the second hybrid connector relatively close to each other in the first direction, the at least one anti-misinsertion projection and/or the second connecting portion of the first hybrid connector is brought into abutment with the fourth wall, the fifth wall, or the sixth wall of the shell of the second hybrid connector.

The shell of the second hybrid connector may further include a lock portion provided at the sixth wall such as to project to the one side in the third direction. The lock portion of the second hybrid connector may be provided with a guide hole. The guide hole may extend in the first direction, open to the other side in the first direction, extend through the sixth wall, and communicate with the second connecting hole. The lock portion of the second hybrid connector may include a wall on the one side in the second direction relative to the guide hole, and the wall may be provided with a lock hole. The lock hole may extend from the guide hole to the one side in the second direction and communicating with the guide hole.

The connection structure may be configured such that, in a state where the first connecting portion and the second connecting portion of the first hybrid connector face the first connecting hole and the second connecting hole of the second hybrid connector, respectively, in the first direction, the or each anti-misinsertion projection of the first hybrid connector faces the or a corresponding anti-misinsertion recess of the second hybrid connector in the first direction, the bounding wall of the second hybrid connector faces the gap of the first hybrid connector in the first direction, and the lock portion of the first hybrid connector faces the guide hole of the lock portion of the second hybrid connector in the first direction, by bringing the first hybrid connector and the second hybrid connector relatively close to each other in the first direction, the first connecting portion and the second connecting portion of the first hybrid connector are received into the first connecting hole and the second connecting hole, respectively, of the second hybrid connector, the or each anti-misinsertion projection of the first hybrid connector is received into the or a corresponding anti-misinsertion recess of the second hybrid connector, the bounding wall of the shell of the second hybrid connector is received into the gap of the first hybrid connector, the lock portion of the first hybrid connector is received into the guide hole of the lock portion of the second hybrid connector, and then the lock projection of the lock portion of the first hybrid connector is fitted into the lock hole of the lock portion of the second hybrid connector.

The connection structure may be configured such that, in a state where the first connecting portion of the first hybrid connector faces the second connecting hole of the second hybrid connector in the first direction, and the second connecting portion of the first hybrid connector faces the lock portion of the second hybrid connector in the first direction, by bringing the first hybrid connector and the second hybrid connector relatively close to each other in the first direction, the second connecting portion and/or the at least one anti-misinsertion projection of the first hybrid connector is brought into abutment with an edge of the guide hole of the lock portion of the second hybrid connector.

The second hybrid connector may further include a ground terminal disposed in the first connecting hole of the shell and electrically connected to the shell.

The connection structure may be configured such that, when the first connecting portion and the second connecting portion of the first hybrid connector are received into the first connecting hole and the second connecting hole, respectively, of the second hybrid connector, the first connecting portion of the first hybrid connector comes into contact with the ground terminal of the second hybrid connector before the first contact portion of the or each first terminal of the first hybrid connector comes into contact with the first contact portion of the or a corresponding first terminal of the second hybrid connector, and before the second contact portion of the or each second terminal of the first hybrid connector comes into contact with the second contact portion of the or a corresponding second terminal of the second hybrid connector.

### BRIEF DESCRIPTION OF DRAWINGS

FIG. 1A is a front, top, left side perspective view of a first hybrid connector according to a first embodiment of the invention.

FIG. 1B is a front, bottom, right side perspective view of the first hybrid connector.

FIG. 1C is a front view of the first hybrid connector.

FIG. 1D is a bottom view of the first hybrid connector.

FIG. 2A is a cross-sectional view of the first hybrid connector taken along line 2A-2A in FIG. 1C.

FIG. 2B is a cross-sectional view of the first hybrid connector taken along line 2B-2B in FIG. 1C.

FIG. 2C is a cross-sectional view of the first hybrid connector taken along line 2C-2C in FIG. 1C.

FIG. 2D is a cross-sectional view of the first hybrid connector taken along line 2D-2D in FIG. 1D.

FIG. 2E is a cross-sectional view of the first hybrid connector taken along line 2E-2E in FIG. 1D.

FIG. 3A is a front, top, left side perspective view of a first assembly and a second assembly in an exploded state of the first hybrid connector.

FIG. 3B is a rear, top, right side perspective view of the first assembly and the second assembly in an exploded state of the first hybrid connector.

FIG. 3C is a front, bottom, left side perspective view of the first assembly and the second assembly in an exploded state of the first hybrid connector.

FIG. 4A is a front, top, right side perspective exploded view of the first assembly of the first hybrid connector.

FIG. 4B is a rear, bottom, left side perspective view of the first assembly of the first hybrid connector.

FIG. 5A is a rear, top, left side perspective view of the second hybrid connector according to the first embodiment of the invention.

FIG. 5B is a front, bottom, left side perspective view of the second hybrid connector.

FIG. 5C is a rear view of the second hybrid connector.

FIG. 5D is a front view of the second hybrid connector.

FIG. 6A is a cross-sectional view of the second hybrid connector taken along line 6A-6A in FIG. 5C.

FIG. 6B is a cross-sectional view of the second hybrid connector taken along line 6B-6B in FIG. 5C.

FIG. 6C is a cross-sectional view of the second hybrid connector taken along line 6C-6C in FIG. 5C.

FIG. 7A is a rear, top, left side perspective view of the second hybrid connector.

FIG. 7B is a front, top, right side perspective view of the second hybrid connector.

FIG. 8A is a front, top, left side perspective view of a connection structure (combination) of the first hybrid connector and the second hybrid connector according to the first embodiment of the invention.

FIG. 8B is a cross-sectional view of the connection structure taken along line 8B-8B in FIG. 8A.

FIG. 8C is a cross-sectional view of the connection structure taken along line 8C-8C in FIG. 8A.

In the brief description of the drawings above and the description of embodiments which follows, relative spatial terms such as “upper”, “lower”, “top”, “bottom”, “left”, “right”, “front”, “rear”, etc., are used for the convenience of the skilled reader and refer to the orientations of the hybrid connectors and the connection structures of hybrid connectors, as well as their constituent parts as depicted in the drawings. No limitation is intended by use of these terms, either in use of the invention, during its manufacture, shipment, custody, or sale, or during assembly of its constituent parts or when incorporated into or combined with other apparatus.

### DESCRIPTION OF EMBODIMENTS

A plurality of embodiments of the invention, including first and second embodiments and variants thereof, will now be described. It should be noted that constituents of the embodiments and their variants to be described can be combined in any possible manner. It should also be noted that the materials, the shapes, the dimensions, the numbers, the arrangements, etc. of the constituents of the embodiments and their variants to be described are presented by way of example only and can be modified in any manner as long as the same functions can be fulfilled.

First Embodiment

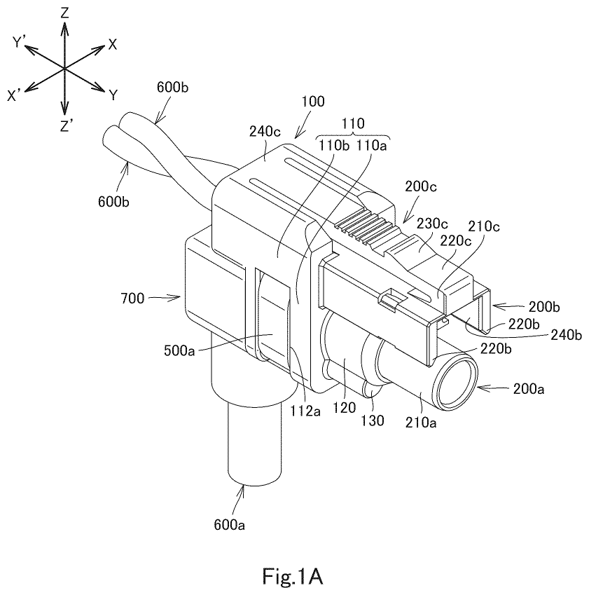

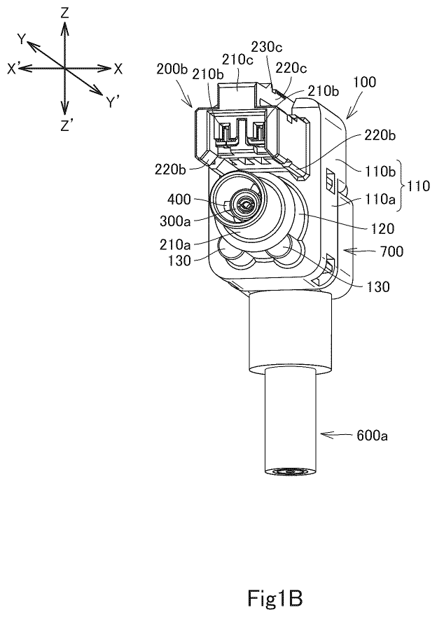

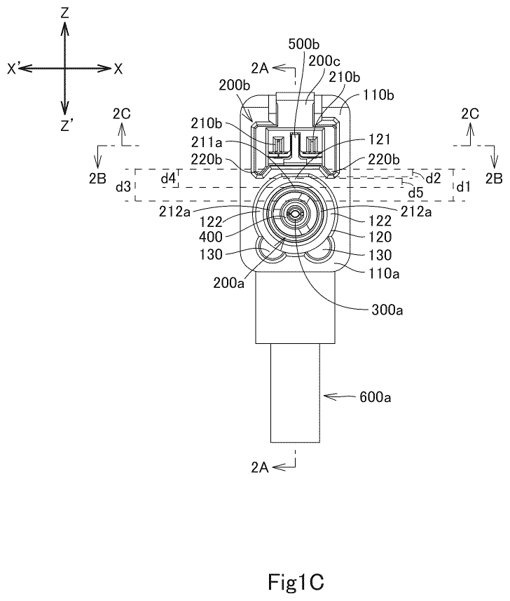

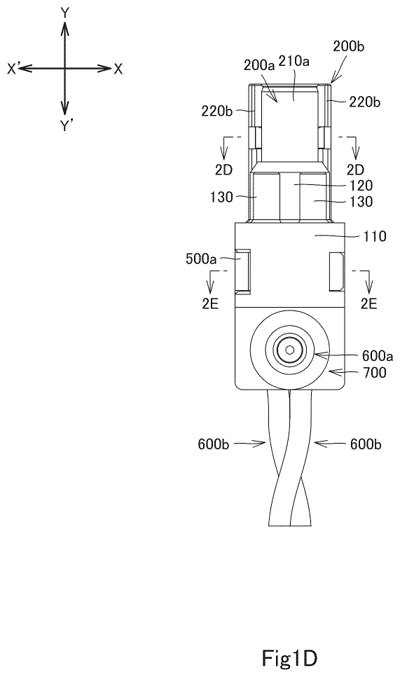

A hybrid connector C1 (first hybrid connector) according to a plurality of embodiments of the invention, including the first embodiment and its variants, will now be described with reference to FIGS. 1A to 4B. FIGS. 1A to 4B illustrate the hybrid connector C1 of the first embodiment. FIGS. 1A, 1B, 1D to 2C, and 3A to 4B show a Y-Y′ direction (first direction). The Y-Y′ direction includes a Y direction (one side in the first direction) and a Y′ direction (the other side in the first direction). FIGS. 1A to 1C, 2A, 2D, 2E, and 3A to 4B show a Z-Z′ direction (second direction). The Z-Z′ direction is substantially orthogonal to the Y-Y′ direction and includes a Z direction (one side in the second direction) and a Z′ direction (the other side in the second direction). FIGS. 1A to 1D, 2B to 2E, and 3A to 4B show an X-X′ direction (third direction). The X-X′ direction is substantially orthogonal to the Y-Y′ and Z-Z′ directions and includes an X direction (one side in the third direction) and an X′ direction (the other side in the third direction).

The hybrid connector C1 includes a housing 100 having an insulating property, a first connecting portion 200a, and a second connecting portion 200b.

The housing 100 is constituted by an insulating material, e.g., an insulating resin or the like. The housing 100 includes a body portion 110. The body portion 110 includes a first body portion 110a and a second body portion 110b on the Z-direction side relative to the first body portion 110a.

The first body portion 110a includes a first end face on the Y-direction side, a second end face on the Y′-direction side, a third end face on the X-direction side, and a fourth end face on the X′-direction side. A first housing space 111a is provided inside the first body portion 110a. The first housing space 111a extends through the first body portion 110a, from the first end face to the second end face thereof.

A first engaging hole 112a may further be provided inside the first body portion 110a. The first engaging hole 112a includes a first vertical hole, a first lateral hole on the Z-direction side, a first lateral hole on the Z′-direction side, a first engaging portion 112a1 on the Z-direction side, and a first engaging portion 112a1 on the Z′-direction side. The first vertical hole is provided in the fourth end face of the first body portion 110a, is located on the X′-direction side relative to the first housing space 111a, communicates with the first housing space 111a, and opens in the X′ direction. The first lateral hole on the Z-direction side extends from the first vertical hole in the X direction, is located on the Z-direction side relative to the first housing space 111a, communicates with the first housing space 111a, and opens in the X direction. The first lateral hole on the Z′-direction side extends from the first vertical hole in the X direction, is located on the Z′-direction side relative to the first housing space 111a, communicates with the first housing space 111a, and opens in the X direction. The first engaging portion 112a1 on the Z-direction side may be a projection projecting to the Z-direction side, provided at an edge portion on the Z′-direction side of the first lateral hole on the Z-direction side, or may alternatively be this edge portion itself or the like. The first engaging portion 112a1 on the Z′-direction side may be a projection projecting to the Z′-direction side, provided at an edge portion on the Z-direction side of the first lateral hole on the Z′-direction side, or may alternatively be this edge portion itself or the like. The first engaging hole 112a can be omitted.

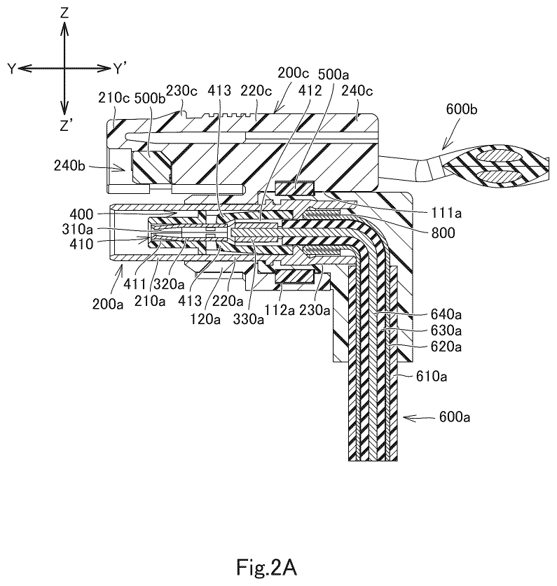

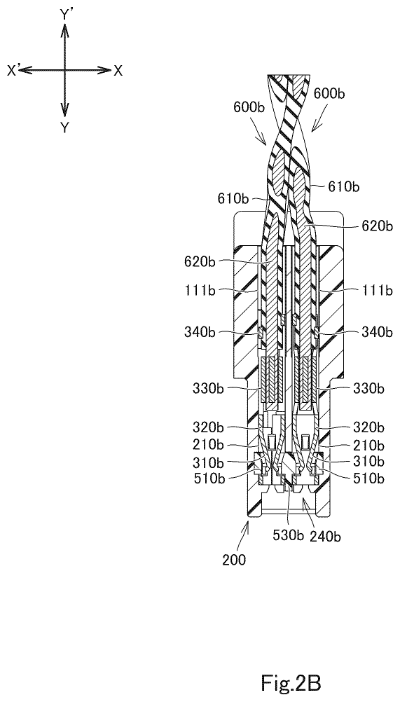

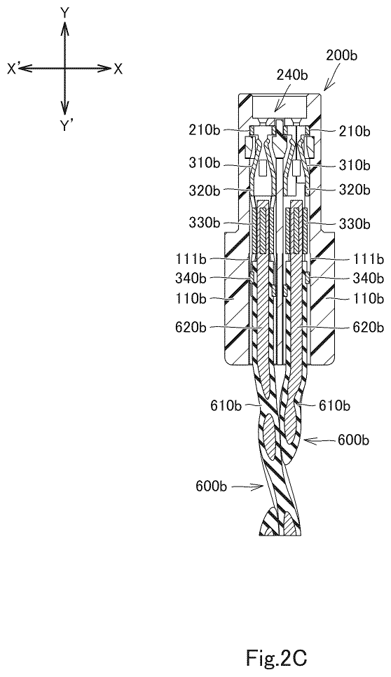

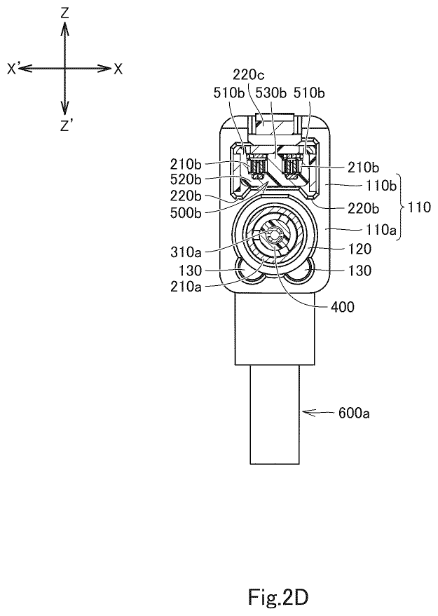

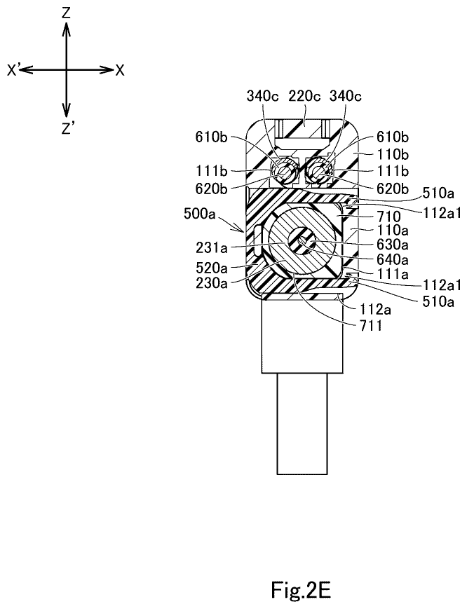

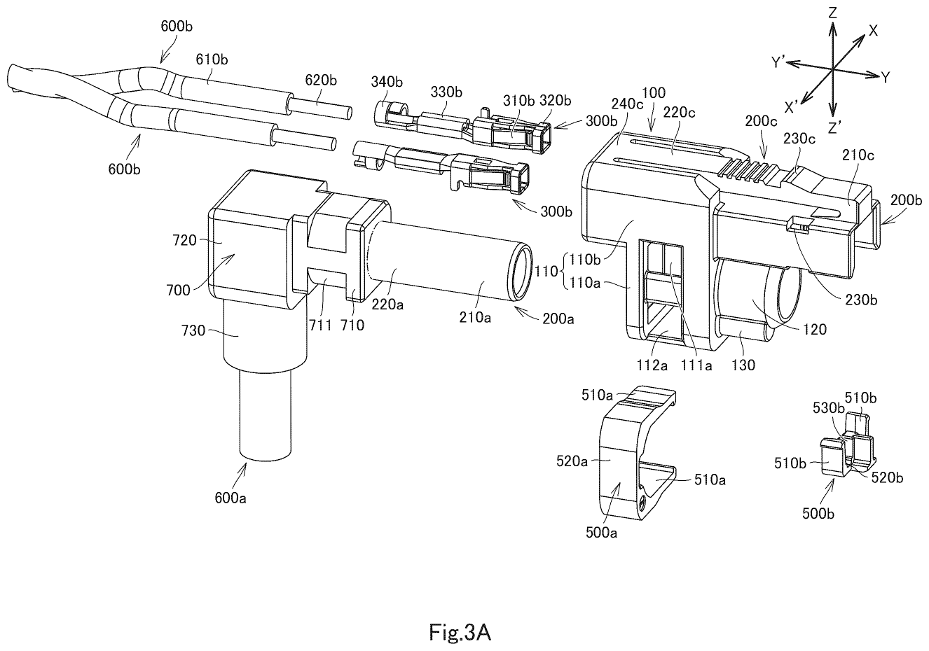

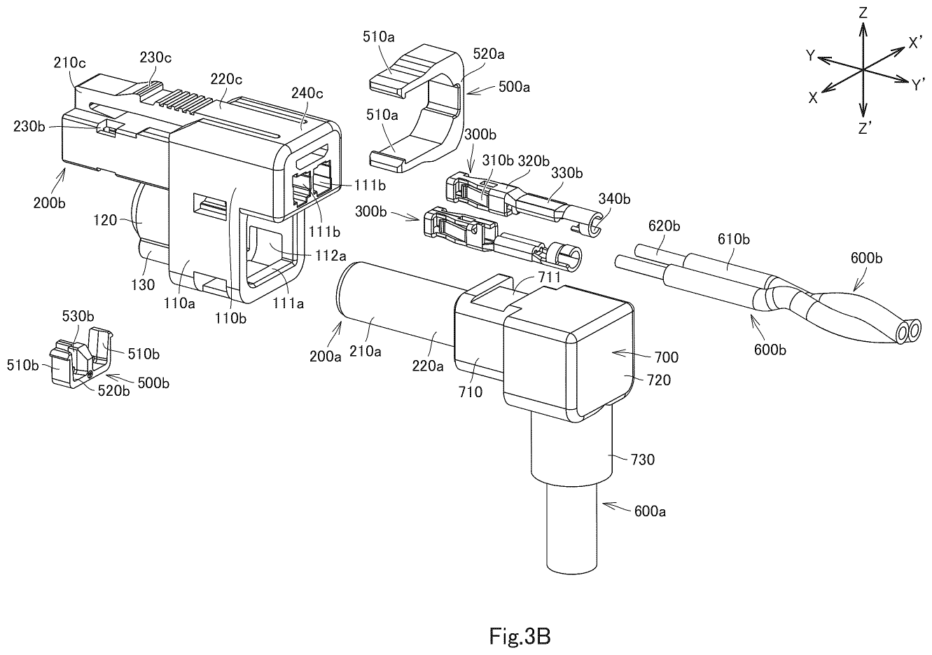

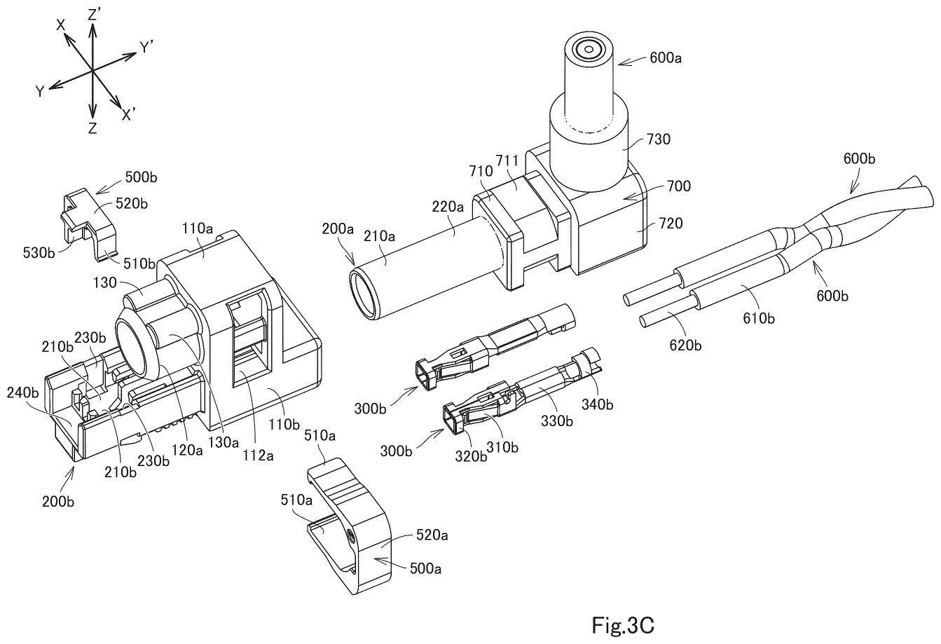

The second body portion 110b includes a first end face on the Y-direction side, a second end face on the Y′-direction side, a third end face on the X-direction side, a fourth end face on the X′-direction side, and a fifth end face on the Z-direction side. At least one second housing space 111b is provided inside the second body portion 110b. The at least one second housing space 111b may be a single second housing space 111b (not illustrated) or a plurality of second housing spaces 111b (see FIGS. 2B to 2C, 2E, and 3B). The second housing space or spaces 111b extend through the second body portion 110b, from the first end face to the second end face thereof. The plurality of second housing spaces 111b are arranged in spaced relation to each other in the X-X′ direction.

The housing 100 may further include a tube 120. The tube 120 has a generally circular tubular shape, a generally polygonal tubular shape, a generally circular tubular shape that is partly cut away, or a generally polygonal tubular shape that is partly cut away. In the other words, the tube 120 is a tube having a cross section along the Z-Z′ and the X-X′ directions of a generally circular shape, a generally polygonal shape, a generally circular shape that is partly cut away, or a generally polygonal shape that is partly cut away. The tube 120 extends in the Y direction from the first end face of the first body portion 110a of the body portion 110. The inside (inner space) of the tube 120 communicates with the first housing space 111a. The tube 120 partly fits over the first connecting portion 200a.

The tube 120 may include a first portion 121 and at least one second portion 122. The first portion 121 is a portion of the tube 120 that is located on the Z-direction side relative to a central axis of the first connecting portion 200a. The at least one second portion 122 may be a single second portion 122 (not illustrated) or a plurality of second portions 122 (see FIGS. 1C and 2D). The single second portion 122 is a portion of the tube 120 that is located on the X- or X′-direction side relative to the first portion 121 and located on the Z′-direction side relative to the first portion 121. The single second portion 122 may be an end portion on the X- or X′-direction side of the tube 120, or alternatively be a portion of the tube 120 that is located between the first portion 121 and the end portion on the X- or X′-direction side of the tube 120. The plurality of second portions 122 include a second portion 122 on the X-direction side and a second portion 122 on the X′-direction side. The second portion 122 on the X-direction side is a portion of the tube 120 that is located on the X-direction side relative to the first portion 121 and located on the Z′-direction side relative to the first portion 121. The second portion 122 on the X-direction side may be an end portion on the X-direction side of the tube 120, or alternatively be a portion of the tube 120 that is located between the first portion 121 and the end portion on the X-direction side of the tube 120. The second portion 122 on the X′-direction side is a portion of the tube 120 that is located on the X′-direction side relative to the first portion 121 and located on the Z′-direction side relative to the first portion 121. The second portion 122 on the X′-direction side may be an end portion on the X′-direction side of the tube 120, or alternatively be a portion of the tube 120 that is located between the first portion 121 and the end portion on the X′-direction side of the tube 120. A linear distance d1 in the Z-Z′ direction between the single second portion 122 and the second connecting portion 200b, or alternatively each linear distance d1 in the Z-Z′ direction between each of the second portions 122 and the second connecting portion 200b, is larger than a linear distance d2 in the Z-Z′ direction between the first portion 121 and the second connecting portion 200b.

It is possible to omit the first portion 121 and the at least one second portion 122 of the tube 120. In this case, the tube 120 may have a quadrangular tubular shape (i.e., a tube with a quadrangular cross section along the Z-Z′ and the X-X′ directions), and the linear distance between a face on the Z-direction side of the tube 120 and the second connecting portion 200b may be the same from the end on the X-direction side to the end on the X′-direction side of the face on the Z-direction side of the tube 120.

The hybrid connector C1 may further include at least one first keying projection 130. The at least one first keying projection 130 may be a single keying projection 130 (not illustrated) or a plurality of keying projections 130 (see FIGS. 1A to 2A, 2D, and 3A to 3C).

For convenience of description, the at least one first keying projection 130 may also be hereinafter referred to as “the or each first keying projection 130”. Where a single first keying projection 130 is provided, “the first keying projection 130” of “the or each first keying projection 130” means the single first keying projection 130, and where a plurality of first keying projections 130 is provided, “each first keying projection 130” of “the or each first keying projection 130” means each of the first keying projections 130.

The or each first keying projection 130 is constituted by an insulating material, e.g., an insulating resin or the like, and projects from the outer peripheral face of the tube 120. The or each first keying projection 130 may have a cross section along the Z-Z′ and the X-X′ directions of a generally semicircular shape (see FIGS. 1A to 2A, 2D, and 3A to 3C), a generally quadrangular shape (not illustrated), a generally trapezoidal shape (not illustrated), or any other shape. The or each first keying projection 130 may have a dimension in the Y-Y′ direction that is substantially equal to, or smaller than, a dimension in the Y-Y′ direction of the tube 120.

The single first keying projection 130 is integral and contiguous with the outer peripheral face of the tube 120 such as to project in a first oblique direction, a second oblique direction, the X direction, or the X′ direction. The first oblique direction includes components of the X and Z′ directions. The second oblique direction includes components in the X′ and Z′ directions.

The plurality of first keying projections 130 include a first keying projection 130 on the X-direction side and a first keying projection 130 on the X′-direction side. The first keying projection 130 on the X-direction side is integral and contiguous with the outer peripheral face of the tube 120 and projects in the first oblique direction or the X direction. The first keying projection 130 on the X′-direction side is integral and contiguous with the outer peripheral face of the tube 120 and projects in the second oblique direction or the X′ direction.

It is possible to omit the tube 120 and the at least one first keying projection 130. It is also possible to omit the at least one first keying projection 130 but not the tube 120.

The first connecting portion 200a is only required to protrude from the housing 100 in the Y-Y′ direction. The Y-Y′ direction corresponds to the direction in which the first connecting portion 200a projects (the projecting direction of the first connecting portion 200a).

The first connecting portion 200a may have a tubular shape extending in the Y-Y′ direction, and have electrical conductivity, and be retained by the housing 100, for example. More specifically, the first connecting portion 200a may have a tubular shape extending in the Y-Y′ direction, which is provided separately from the body portion 110 and constituted by an electrically conductive material (e.g., a metal or a carbon material such as a carbon nanotube). Alternatively, the first connecting portion 200a may include a tubular body extending in the Y-Y′ direction, which is provided separately from the body portion 110 and constituted by an insulating material, and a metal film plated or vapor-deposited on at least one of an outer face or an inner face of the body. The central axis of the first connecting portion 200a extends in the Y-Y′ direction through the center of the first connecting portion 200a.

The first connecting portion 200a includes a protruding portion 210a and a retainable portion 220a. The protruding portion 210a is a portion on the Y-direction side of the first connecting portion 200a, has a generally circular tubular shape or a generally polygonal tubular shape (tubular shape with a generally circular or polygonal cross section along the Z-Z′ and the X-X′ directions), and includes a distal end face on the Y-direction side. The retainable portion 220a is a portion of the first connecting portion 200a that is located on the Y′-direction side relative to the protruding portion 210a, and has a generally circular tubular shape or a generally polygonal tubular shape (a tubular shape with a generally circular or polygonal cross section along the Z-Z′ and the X-X′ directions).

The first connecting portion 200a may further include a rear portion 230a. The rear portion 230a is a portion on the Y′-direction side of the first connecting portion 200a, has a generally circular tubular shape or a generally polygonal tubular shape (a tubular shape having a generally circular or polygonal cross section along the Z-Z′ and the X-X′ directions), and is located on the Y′-direction side relative to the retainable portion 220a. The rear portion 230a may or may not include an abutment 231a of an annular or polygonal ring shape inwardly projecting from the inner peripheral face of the rear portion 230a.

Where the tube 120 of the housing 100 is provided (see FIGS. 1A to 3C), the retainable portion 220a of the first connecting portion 200a has an outer shape and outer dimensions in a cross section along the Z-Z′ and X-X′ directions that correspond to an inner shape and inner dimensions in a cross section along the Z-Z′ and X-X′ directions of the tube 120. Also, the retainable portion 220a of the first connecting portion 200a is securely received in the tube 120, the rear portion 230a of the first connecting portion 200a is at least partly housed in the first housing space 111a of the first body portion 110a of the housing 100, and the protruding portion 210a of the first connecting portion 200a protrudes in the Y direction from the tube 120.

Where the tube 120 is not provided (not illustrated), the retainable portion 220a of the first connecting portion 200a is retained in the first housing space 111a of the first body portion 110a of the housing 100, the rear portion 230a of the first connecting portion 200a is at least partly housed in the first housing space 111a of the first body portion 110a of the housing 100, and the protruding portion 210a of the first connecting portion 200a protrudes in the Y direction from the first body portion 110a of the housing 100.

The protruding portion 210a of the first connecting portion 200a includes a first portion 211a and at least one second portion 212a. The first portion 211a is a portion of the first connecting portion 200a that is located on the Z-direction side relative to the central axis of the first connecting portion 200a. The at least one second portion 212a may be a single second portion 212a (not illustrated) or a plurality of second portions 212a (see FIGS. 1C and 2D). The single second portion 212a is a portion of the first connecting portion 200a that is located on the X- or X′-direction side relative to the first portion 211a and located on the Z′-direction side relative to the first portion 211a. The single second portion 212a may be an end portion on the X- or X′-direction side of the second connecting portion 200b, or may be a portion of the second connecting portion 200b that is located between the first portion 211a and the end portion on the X- or X′-direction side of the second connecting portion 200b. The plurality of second portions 212a include a second portion 212a on the X-direction side and a second portion 212a on the X′-direction side. The second portion 212a on the X-direction side is a portion of the first connecting portion 200a that is located on the X-direction side relative to the first portion 211a and located on the Z′-direction side relative to the first portion 211a. The second portion 212a on the X-direction side may be an end portion on the X-direction side of the second connecting portion 200b, or alternatively be a portion of the second connecting portion 200b that is located between the first portion 211a and the end on the X-direction side of the second connecting portion 200b. The second portion 212a on the X′-direction side is a portion of the first connecting portion 200a that is located on the X′-direction side relative to the first portion 211a and located on the Z′-direction side relative to the first portion 211a. The second portion 212a on the X′-direction side may be an end portion on the X′-direction side of the second connecting portion 200b, or alternatively be a portion of the second connecting portion 200b that is located between the first portion 211a and the end on the X′-direction side of the second connecting portion 200b. A linear distance d3 in the Z-Z′ direction between the single second portion 212a and the second connecting portion 200b, or alternatively each linear distance d3 in the Z-Z′ direction between each of the second portion 212a and the second connecting portion 200b, is larger than a linear distance d4 in the Z-Z′ direction between the first portion 211a and the second connecting portion 200b.

It is possible to omit the first portion 211a and the at least one second portion 212a of the first connecting portion 200a can be omitted. In this case, the first connecting portion 200a may have a quadrangular tubular shape (i.e., a tubular shape with a quadrangular cross section along the Z-Z′ and the X-X′ directions), and a linear distance between a face on the Z-direction side of the first connecting portion 200a and the second connecting portion 200b may be equal to a distance from the end on the X-direction side to the end on the X′-direction side of the face on the Z-direction side of the first connecting portion 200a.

The second connecting portion 200b is only required to protrude from the housing 100 in the Y-Y′ direction and be disposed on the Z-direction side relative to, and in spaced relation to, the first connecting portion 200a.

The second connecting portion 200b may be constituted by an insulating material, e.g., an insulating resin or the like, and integral and contiguous with the end face on the Y-direction side of the body portion 110. More specifically, the second connecting portion 200b is integral and contiguous with the first end face of the second body portion 110b of the body portion 110 and may protrude in the Y direction from the first end face of the second body portion 110b. The second connecting portion 200b includes a distal end face on the Y-direction side, a first side face on the X-direction side, and a second side face on the X′-direction side. The second connecting portion 200b includes a distal portion on the Y-direction side, which includes the distal end face.

The second connecting portion 200b may have a dimension in the Y-Y′ direction that is substantially equal to, smaller than, or larger than, a dimension in the Y-Y′ direction of the protruding portion 210a of the first connecting portion 200a. Where the dimension in the Y-Y′ direction of the second connecting portion 200b is larger than that of the protruding portion 210a of the first connecting portion 200a, the distal end face of the second connecting portion 200b is located on the Y-direction side relative to the distal end face of the protruding portion 210a of the first connecting portion 200a. The second connecting portion 200b may have a dimension in the X-X′ direction that is substantially equal to, smaller than, or larger than a dimension in the X-X′ direction of the protruding portion 210a of the first connecting portion 200a. The dimension in the X-X′ direction of the second connecting portion 200b may, but is not required to, be larger or smaller than a dimension in the Z-Z′ direction of the second connecting portion 200b.

The second connecting portion 200b includes at least one terminal housing portion 210b. The at least one terminal housing portion 210b is a single terminal housing portion 210b (not illustrated) or a plurality of terminal housing portions 210b (see FIGS. 1B to 1C, 2B to 2D, and 3C). The single terminal housing portion 210b communicates with the second housing space 111b of the second body portion 110b of the housing 100 and opens in at least one of the Y direction or the Z′ direction. The terminal housing portions 210b communicate with the respective second housing spaces 111b of the second body portion 110b of the housing 100 and open in at least one of the Y direction or the Z′ direction. The terminal housing portions 210b are arranged in spaced relation to each other in the X-X′ direction.

The second connecting portion 200b may further include a pair of second engaging holes 230b (engaging holes of the second connecting portion). Where the tube 120 is provided, the second engaging holes 230b are located on the Y-direction side relative to the tube 120 and on the Z-direction side relative to the protruding portion 210a of the first connecting portion 200a. Where the tube 120 is not provided, the second engaging holes 230b are located on the Z-direction side relative to the protruding portion 210a of the first connecting portion 200a. The second engaging holes 230b includes a second engaging hole 230b on the X-direction side and a second engaging hole 230b on the X′-direction side. The second engaging hole 230b on the X-direction side includes a second vertical hole, a second lateral hole, and a second engaging portion. The second vertical hole of the second engaging hole 230b on the X-direction side is disposed on the X-direction side relative to the terminal housing portion or portions 210b, extends in the Z-Z′ direction, and opens at least to the Z′-direction side. The second lateral hole of the second engaging hole 230b on the X-direction side extends in the X direction from a portion on the Z-direction side of the second vertical hole of the second engaging hole 230b on the X-direction side, and communicates with the second vertical hole. The second engaging portion of the second engaging hole 230b on the X-direction side is an edge on the Z′-direction side of the second lateral hole of the second engaging hole 230b on the X-direction side, a projection on the edge, or the like. The second engaging hole 230b on the X′-direction side includes a second vertical hole, a second lateral hole, and a second engaging portion. The second vertical hole of the second engaging hole 230b on the X′-direction side is disposed on the X′-direction side relative to the terminal housing portion or portions 210b, extends in the Z-Z′ direction, and opens at least to the Z′-direction side. The second lateral hole of the second engaging hole 230b on the X′-direction side extends in the X′ direction from a portion on the Z-direction side of the second vertical hole of the second engaging hole 230b on the X-direction side, and communicates with the second vertical hole. The second engaging portion of the second engaging hole 230b on the X′-direction side is an edge on the Z′-direction side of the second lateral hole of the second engaging hole 230b on the X′-direction side, a projection on the edge, or the like. The pair of second engaging holes 230b can be omitted.

The second connecting portion 200b may further include a connecting hole 240b. The connecting hole 240b is provided in a portion of the second connecting portion 200b that is located on the Y-direction side relative to the terminal housing portion or portions 210b. The connecting hole 240b opens in the Y direction and communicates with the terminal housing portion or portions 210b. The connecting hole 240b may, but is not required to, open also in the Z′ direction.

The hybrid connector C1 further includes at least one anti-misinsertion projection 220b. The at least one anti-misinsertion projection 220b is a single anti-misinsertion projection 220b (not illustrated) or a plurality of anti-misinsertion projections 220b (see FIGS. 1A to 2A, 2D, and 3A to 3C), is provided at the second connecting portion 200b such as to project in the Z′ direction (i.e., toward the first connecting portion 200a), and is disposed between the first connecting portion 200a and the second connecting portion 200b. There is a gap G (see FIG. 2D) between the at least one anti-misinsertion projection 220b and the second connecting portion 200b (i.e., the combination of the at least one anti-misinsertion projection 220b and the second connecting portion 200b), and the protruding portion 210a of the first connecting portion 200a.

For convenience of description, the at least one anti-misinsertion projection 220b may also be hereinafter referred to as “the or each anti-misinsertion projection 220b”. Where a single anti-misinsertion projection 220b is provided, “the anti-misinsertion projection 220b” of “the or each anti-misinsertion projection 220b” means the single anti-misinsertion projection 220b, and where a plurality of misinsertion projections 220b is provided, “each anti-misinsertion projection 220b” means each of the anti-misinsertion projections 220b.

The or each anti-misinsertion projection 220b may be constituted by an insulating material, e.g., an insulating resin or the like, and integral and contiguous with the second connecting portion 200b and may project in the Z′ direction. The or each anti-misinsertion projection 220b may have a cross section along the Z-Z′ and the X-X′ directions of a generally trapezoidal shape (see FIG. 2D), a generally quadrangular shape, a generally semicircular shape, or any other shape. The or each anti-misinsertion projection 220b may have a dimension in the Y-Y′ direction that is substantially equal to, or smaller than, the dimension in the Y-Y′ direction of the second connecting portion 200b. The or each anti-misinsertion projection 220b has a dimension in the X-X′ direction that is smaller than the dimension in the X-X′ direction of the second connecting portion 200b. The or each anti-misinsertion projection 220b is disposed in the Z-Z′ direction in spaced relation to the first connecting portion 200a and/or the tube 120 (if provided) of the housing 100. When viewed from the Z′-direction side, the or each anti-misinsertion projection 220b may or may not be disposed such as to at least partly overlap the first connecting portion 200a and/or the tube 120 (if provided) of the housing 100. The or each anti-misinsertion projection 220b is disposed at a position not interfering with the opening on the Z′-direction side of the terminal housing portion 210b or the openings on the Z′-direction side of terminal housing portions 210b.

The single anti-misinsertion projection 220b protrudes neither beyond the first side face of the second connecting portion 200b in the X direction nor beyond the second side face of the second connecting portion 200b in the X′ direction. More specifically, the end face on the X-direction side of the single anti-misinsertion projection 220b may be located on the X′-direction side relative to the first side face of the second connecting portion 200b, and the end face on the X′-direction side of the single anti-misinsertion projection 220b may be located on the X-direction side relative to the second side face of the second connecting portion 200b. Alternatively, the end face on the X-direction side of the single anti-misinsertion projection 220b may be flush with the first side face of the second connecting portion 200b, while the end face on the X′-direction side of the single anti-misinsertion projection 220b may be located on the X-direction side relative to the second side face of the second connecting portion 200b. Still alternatively, the end face on the X-direction side of the single anti-misinsertion projection 220b may be located on the X′-direction side relative to the first side face of the second connecting portion 200b, while the end face on the X′-direction side of the single anti-misinsertion projection 220b may be flush with the second side face of the second connecting portion 200b.

Where the single second portion 122 of the tube 120 of the housing 100 and/or the single second portion 212a of the first connecting portion 200a are provided, (1) the single anti-misinsertion projection 220b may project toward the second portion 122 of the tube 120 and/or the second portion 212a of the first connecting portion 200a (not illustrated), or alternatively (2) it may project toward the first portion 121 of the tube 120 and/or the first portion 211a of the first connecting portion 200a (not illustrated).

Where the plurality of second portions 122 of the tube 120 of the housing 100 and/or the plurality of second portions 212a of the first connecting portion 200a are provided, (3) the single anti-misinsertion projection 220b may project toward the one of the second portions 122 of the tube 120 and/or one of second portions 212a of the first connecting portion 200a (not illustrated), or alternatively (4) it may project toward the first portion 121 of the tube 120 and/or the first portion 211a of the first connecting portion 200a (not illustrated).

The plurality of anti-misinsertion projections 220b are arranged in spaced relation to each other in the X-X′ direction. The plurality of anti-misinsertion projections 220b include an endmost anti-misinsertion projection 220b to the X-direction side and an endmost anti-misinsertion projection 220b to the X′-direction side. The endmost anti-misinsertion projection 220b to the X-direction side does not protrude in the X direction beyond the first side face of the second connecting portion 200b. The end face on the X-direction side of the endmost anti-misinsertion projection 220b to the X-direction side may be flush with the first side face of the second connecting portion 200b (see FIGS. 1C and 2D), or alternatively be located on the X′-direction side relative to the first side face of the second connecting portion 200b (not illustrated). The endmost anti-misinsertion projection 220b to the X′-direction side does not protrude in the X′ direction beyond the second side face of the second connecting portion 200b. The end face on the X′-direction side of the endmost anti-misinsertion projection 220b to the X′-direction side may be flush with the second side face of the second connecting portion 200b (see FIGS. 1C and 2D), or alternatively be located on the X-direction side relative to the second side face of the second connecting portion 200b (not illustrated).

Where the plurality of second portions 122 of the tube 120 of the housing 100 and/or the plurality of second portions 212a of the first connecting portion 200a are provided, (5) the plurality of anti-misinsertion projections 220b may project toward the second portions 122 of the tube 120 and/or the second portions 212a of the first connecting portion 200a (see Figs. IC and 2D). Alternatively, (6) one of the anti-misinsertion projections 220b (one of all the anti-misinsertion projections 220b) may protrude toward the first portion 121 of the tube 120 and/or the first portion 211a of the first connecting portion 200a, and the remaining one or the remaining ones (of a plural number one fewer than the number of all the anti-misinsertion projections 220b) of the anti-misinsertion projections 220b may project toward one or more (of a plural number one fewer than the number of all the second portions 122) of the second portions 122 (all the second portions 122) of the tube 120 and/or one or more (of a plural number one fewer than the number of all the second portions 212a) of the second portions 212a (all the second portions 212a) of the first connecting portion 200a (not illustrated).

The anti-misinsertion projection or projections 220b may be provided separately from the second connecting portion 200b, which may be constituted by an electrically conductive material or an insulating material and fixed to the second connecting portion 200b by insert molding or other means.

The hybrid connector C1 may further include at least one second keying projection (not illustrated). The at least one second keying projection may be a single second keying projection or a plurality of second keying projections.

For convenience of description, the at least one second keying projection may also be hereinafter referred to as “the or each second keying projection”. Where a single second keying projection is provided, “the second keying projection” of “the or each second keying projection” means the single second keying projection, and where a plurality of second keying projections is provided, “each second keying projection” of “the or each second keying projection” means each of the second keying projections.

The or each second keying projection is constituted by an insulating material, e.g., an insulating resin or the like, and projects from the second connecting portion 200b. The or each second keying projection may have a cross section along the Z-Z′ and the X-X′ directions of a generally semicircular shape, a generally quadrangular shape, a generally trapezoidal shape, or any other shape. The or each second keying projection may have a dimension in the Y-Y′ direction that is substantially equal to, or smaller than, a dimension in the Y-Y′ direction of the second connecting portion 200b.

The single second keying projection may be integral and contiguous with the first side face of the second connecting portion 200b such as to project in the X direction, or may alternatively be integral and contiguous with the second side face of the second connecting portion 200b so as to protrude in the X′ direction. The plurality of second keying projections includes a second keying projection on the X-direction side and a second keying projection on the X′-direction side. The second keying projection on the X-direction side is integral and contiguous with the first side face of the second connecting portion 200b such as to project in the X direction. The second keying projection on the X′-direction side is integral and contiguous with the outer peripheral face of the tube 120 such as to project in the X′ direction. The at least one second keying projection can be omitted.

The hybrid connector C1 may further include a lock portion 200c. The lock portion 200c may be constituted by an insulating material, e.g., an insulating resin or the like, and integral and contiguous with the fifth end face of the second body portion 110b of the housing 100. The lock portion 200c includes a proximal portion 210c, an arm 220c, and a lock projection 230c.

The proximal portion 210c rises from the distal portion of the second connecting portion 200b to the Z-direction side. The arm 220c extends in the Y′ direction from the proximal portion 210c and is disposed on the Z-direction side relative to, and in spaced relation to, the second connecting portion 200b. The arm 220c may extend in the Y′ direction beyond the first end face of the first body portion 110a of the housing 100. The lock projection 230c is projects from the arm 220c to the Z-direction side.

The lock portion 200c may further include an arch 240c. The arch 240c has a generally inverted U-shape in cross section shape along the X-X′ and Z-Z′ directions, and is fixed to the fifth end face of the second body portion 110b of the housing 100. In this case, the arm 220c extends in the Y′ direction from the proximal portion 210c to the arch 240c, and is disposed on the Z-direction side relative to, and in spaced relation to, the second connecting portion 200b and the second body portion 110b of the housing 100. The arch 240c can be omitted or replaced with another proximal portion rising in the Z direction from the fifth end face of the second body portion 110b of the housing 100. The lock portion 200c may, but is not required to, have a dimension in the Y-Y′ direction that is equal to, or smaller than, a sum of a dimension the sum of the dimension in the Y-Y′ direction of the second connecting portion 200b and the dimension in the Y-Y′ direction of the second body portion 110b of the housing 100. Also, the lock portion 200c can be omitted in its entirety.

The hybrid connector C1 further includes at least one first terminal 300a. The at least one first terminal 300a may be a single terminal (see FIGS. 1B and 1C, 2A, 2D, and 4A and 4B) or a plurality of terminals (not illustrated). The first terminal or terminals 300a are disposed inside the first connecting portion 200a. For convenience of description, the at least one first terminal 300a will be described below as the single terminal 300a, but also where it is the plurality of terminals 300a, it may be configured similarly to what is described below.

The first terminal 300a may be disposed such that an imaginary line (not illustrated) extending in the Y-Y′ direction through the center of the first terminal 300a inside the first connecting portion 200a substantially coincides with the central axis of the first connecting portion 200a. Thus the first terminal 300a and the first connecting portion 200a may form a coaxial structure.

The first terminal 300a is constituted by an electrically conductive material, such as a metal plate, and includes a first contact portion 310a, a first body portion 320a, and a first tail 330a.

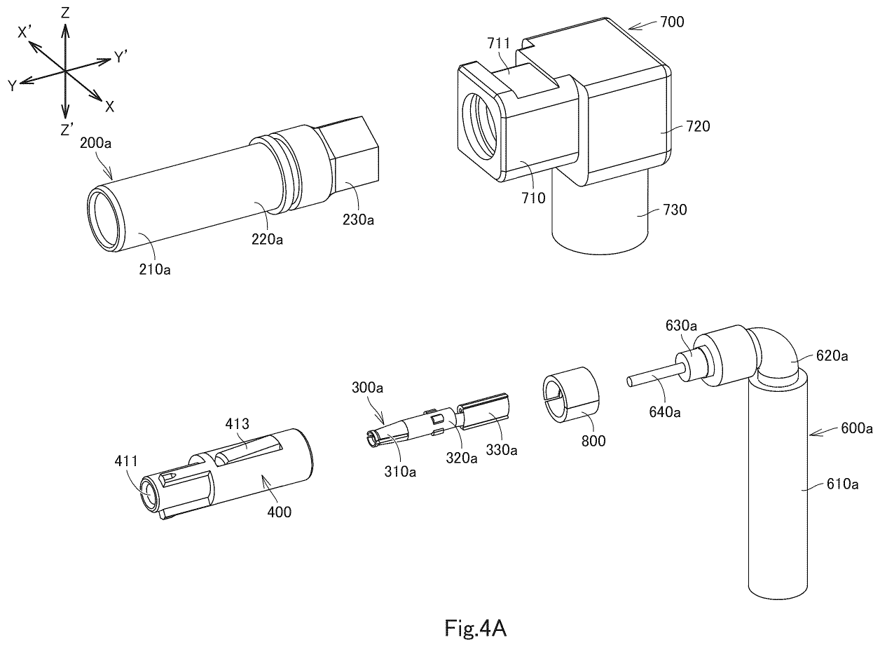

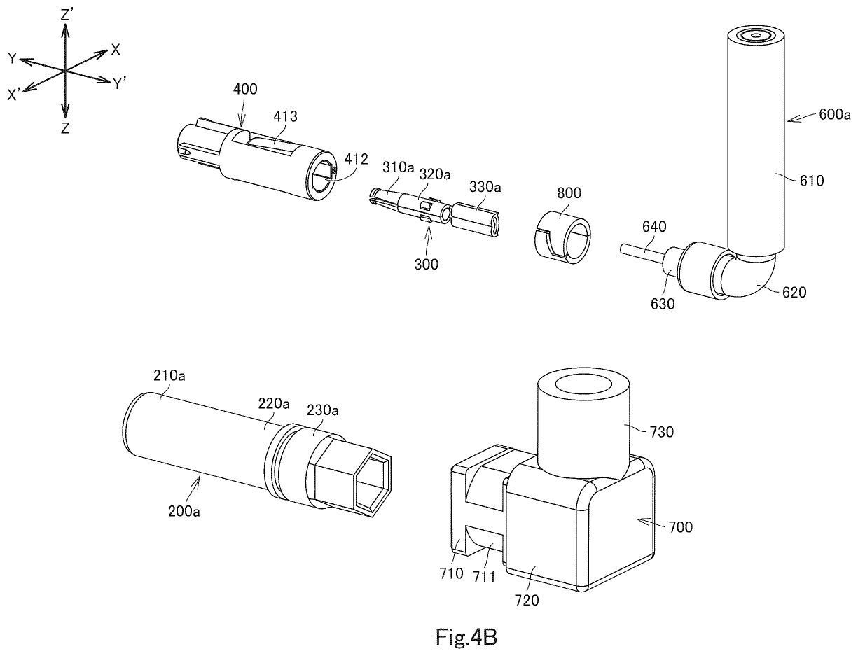

The first body portion 320a is a portion between the first contact portion 310a and the first tail 330a of the first terminal 300a. For example, the first body portion 320a may be constituted by a generally tubular plate extending in the Y-Y′ direction (see FIGS. 2D, 4A, and 4B), a generally U-shaped plate extending in the Y-Y′ direction (not illustrated), a rod extending in the Y-Y′ direction (not illustrated), or the like.

The first contact portion 310a is constituted by a pair of beams (see FIGS. 2A, 4A, and 4B), a rod (not illustrated), a flat plate (not illustrated), a tube (not illustrated), or the like extending in the Y direction from the end on the Y-direction side of the first body portion 320a.

The first tail 330a is constituted by a flat plate, a generally tubular member, a rod, or the like extending in the Y′ direction from the first body portion 320a.

The hybrid connector C1 further includes a body 400. The body 400 is constituted by an insulating material, e.g., an insulating resin or the like. The body 400 includes a portion in the Y-Y′ direction having an outer shape and outer dimensions in a cross section along the Z-Z′ and X-X′ directions that correspond to an inner shape and inner dimensions, respectively, in a cross section along the Z-Z′ and X-X′ directions of the first connecting portion 200a. The body 400 is securely housed in the first connecting portion 200a and retains the first terminal 300a in part. In other words, the first terminal 300a is securely housed in the first connecting portion 200a, together with the body 400. Where the first connecting portion 200a includes the abutment 231a, the body 400 abuts the abutment 231a from the Y-direction side.

The body 400 includes at least one terminal housing portion 410, for example. The at least one terminal housing portion 410 may be a single portion or a plurality of portions in accordance with the number of the at least one first terminal 300a. Since the at least one first terminal 300a is herein described as a single terminal, the at least one terminal housing portion 410 will also be described as a single portion. Also where the at least one terminal housing portion 410 is a plurality of portions, it may be configured similarly to what is described below.

The terminal housing portion 410 is provided inside the body 400 and retains the first terminal 300a in part. The terminal housing portion 410 includes a first housing portion 411 on the Y-direction side and a second housing portion 412 on the Y′-direction side.

The first housing portion 411 is a space extending in the Y-Y′ direction and opens in the Y direction. The first housing portion 411 has a shape and a size in a cross section along the Z-Z′ and X-X′ directions that correspond to an outer shape and outer dimensions, respectively, in a cross section along the Z-Z′ and X-X′ directions of a portion on the Y-direction side of the first body portion 320a of the first terminal 300a. The first housing portion 411 securely houses a portion on the Y-direction side of the first body portion 320a of the first terminal 300a, and houses the first contact portion 310a of the first terminal 300a. The first contact portion 310a of the first terminal 300a is exposed from the first housing portion 411 and exposed from the first connecting portion 200a such as to be viewable from the Y-direction side (from outside the first connecting portion 200a) relative to the first connecting portion 200a.

The second housing portion 412 is a space extending in the Y-Y′ direction, opens in the Y′ direction, and communicates with the first housing portion 411. The second housing portion 412 has a size in the cross section along the Z-Z′ and X-X′ directions that is larger than the size in the cross section along the Z-Z′ and X-X′ directions of the first housing portion 411, than the outer dimensions in the cross section along the Z-Z′ and X-X′ directions of the portion on the Y′-direction side of the first body portion 320a, and than the outer dimensions in the cross section along the Z-Z′ and X-X′ directions of the first tail 330a of the first terminal 300a. The second housing portion 412 houses the portion on the Y′-direction side of the first body portion 320a and the first tail 330a of the first terminal 300a.

The terminal housing portion 410 may further include a pair of retaining arms 413. The retaining arms 413 are formed by cutting out a first wall on the X- or Z-direction side of the second housing portion 412 and a second wall on the X′- or Z′-direction side of the second housing portion 412. Each of the retaining arms 413 includes a distal portion and a proximal portion. The proximal portion of one of the retaining arms 413 is integral and contiguous with the first wall of the second housing portion 412, and the proximal portion of the other retaining arm 413 is integral and contiguous with the second wall of the second housing portion 412. The retaining arms 413 are inclined with the distance therebetween gradually decreasing from the proximal portions to the distal portions. The distal portions of the retaining arms 413 elastically retain the portion on the Y′-direction side of the first body portion 320a of the first terminal 300a. Note that the second housing portion 412 may be provided with a single retaining arm 413 or three or more retaining arms 413. The second housing portion 412 may be provided with no retaining arms 413.

The first body portion 320a of the first terminal 300a may be at least partly retained in the body 400 by insert molding or other means. In this case, the first contact portion 310a of the first terminal 300a is exposed or protrudes from the body 400 in the Y direction, and the first tail 330a of the first terminal 300a is exposed or protrudes from the body 400 in the Y′ direction.

The hybrid connector C1 may further include at least one first cable 600a. The at least one first cable 600a may be a single cable or a plurality of cables in accordance with the number of the at least one first terminal 300a. Since the at least one first terminal 300a is herein described as a single terminal, and the at least one first cable 600a will also be described as a single cable. Also where the at least one first cable 600a is a plurality of cables, it may be configured similarly to what is described below.

The first cable 600a may, but is not required to, be a so-called coaxial cable. The first cable 600a includes an outer insulator 610a, an outer conductor 620a, an inner insulator 630a, and an inner conductor 640a. The outer insulator 610a is a tubular jacket constituted by an insulating material. The outer conductor 620a is a tube constituted by a conductor, such as a copper wire mesh, and is disposed inside the outer insulator 610a. The outer conductor 620a includes a distal portion on the Y-direction side protruding from the outer insulator 610a in the Y direction. The distal portion of the outer conductor 620a may, but is not required to, include a portion on the Y-direction side that is folded back to the Y′-direction side. Further, a conductive ring 800 may be fixed to the distal portion of the outer conductor 620a. For example, the conductive ring 800 may be disposed between the two portions of the folded distal portion of the outer conductor 620a (see FIG. 2A), or alternatively fitted over the distal portion of the outer conductor 620a. The conductive ring 800 may be a conductor formed in a ring shape or may be a ring-shaped insulator with a conductive tape wound therearound. The inner insulator 630a is a tube constituted by an insulating material and is disposed inside the outer conductor 620a. The inner insulator 630a includes a distal portion on the Y-direction side protruding from the outer conductor 620a in the Y direction. The inner conductor 640a is a metal wire, such as a copper wire, and is disposed inside the inner insulator 630a. The inner conductor 640a includes a distal portion on the Y-direction side protruding from the inner insulator 630a in the Y direction. The conductive ring 800 can be omitted.

The distal portion of the inner conductor 640a is received in the rear portion 230a of the first connecting portion 200a and the second housing portion 412 of the body 400 from the Y′-direction side, and is connected to the first tail 330a of the first terminal 300a. The distal portion of the inner insulator 630a is also received in the rear portion 230a of the first connecting portion 200a and the second housing portion 412 of the body 400 from the Y′-direction side. The distal portion of the outer conductor 620a is received in, and in contact with, the rear portion 230a of the first connecting portion 200a. The rear portion 230a may be at least partly swaged such as to come into contact with the distal portion of the outer conductor 620a. The outer conductor 620a and the first connecting portion 200a are electrically connected and at an equal electric potential. Where the conductive ring 800 is fitted over the distal portion of the outer conductor 620a, the distal portion of the outer conductor 620a may be in contact with the rear portion 230a of the first connecting portion 200a via the conductive ring 800.

The hybrid connector C1 may further include a molded part 700. The molded part 700 is constituted by an insulating material, and fixed to the rear portion 230a of the first connecting portion 200a and a portion on the Y-direction side of the first cable 600a by outsert molding or other means. The portion on the Y-direction side of the first cable 600a may be bent in a generally L-shape as shown in FIGS. 1A to 4B, may extend rectilinearly in the Y′ direction, or may extend in any other direction. The molded part 700 includes a first molded portion 710 and a second molded portion 720.

The first molded portion 710 has an outer shape and outer dimensions in a cross section along the Z-Z′ and X-X′ directions that correspond to a shape and dimensions, respectively, in a cross section along the Z-Z′ and X-X′ directions of the first housing space 111a of the housing 100. The first molded portion 710 is received and housed in the first housing space 111a of the housing 100 from the Y′-direction side.

Where the housing 100 is provided with the first engaging hole 112a, the first molded portion 710 may or may not be provided with a groove 711 of a generally C-shape. The groove 711 includes a vertical groove, a lateral groove on the Z-direction side, and a lateral groove on the Z′-direction side. The vertical groove of the groove 711 may be provided in the face on the X′-direction side of the first molded portion 710 and extend in the Z-Z′ direction, or may be sectioned by the groove on the Z-direction side and the groove on the Z′ direction-side. The lateral groove on the Z-direction side of the groove 711 is provided in face on the Z-direction side of the first molded portion 710, extends in the X-X′ direction, and communicates with the vertical groove of the groove 711. The lateral groove on the Z′-direction side of the groove 711 is provided in the face on the Z′-direction side of the first molded portion 710, extends in the X-X′ direction, and communicates with the vertical groove of the groove 711. The vertical groove can be omitted. Only one of the lateral grooves on the Z- or Z′-direction side may be provided.

The second molded portion 720 is a portion on the Y′-direction side relative to the first molded portion 710, and is integral and contiguous with the first molded portion 710. The second molded portion 720 surrounds a portion of the first cable 600a that is located on the Y′-direction side relative to the rear portion 230a of the first connecting portion 200a, and determines a direction in which the first cable 600a extends out of the second molded portion 720.

Where the portion on the Y-direction side of the first cable 600a is bent to the Z′-direction side, the molded part 700 may further include a third molded portion 730. The third molded portion 730 is a portion on the Z′-direction side relative to the second molded portion 720, and is integral and contiguous with the second molded portion 720. The third molded portion 730 is fixed to a portion on the Y-direction side of the outer insulator 610a of the first cable 600a. Where the portion on the Y-direction side of the first cable 600a is bent in a direction other than the Z′-direction side, the third molded portion 730 may extends from the second molded portion 720 in a direction other than the Z′-direction side.

Where the housing 100 is provided with the first engaging hole 112a and the molded part 700 is provided with the groove 711, the hybrid connector C1 may further include a retainer 500a. The retainer 500a is constituted by an insulating material, e.g., an insulating resin or the like. The retainer 500a is a generally C-shaped member and includes a pair of engaging arms 510a and a coupling portion 520a. The pair of engaging arms 510a includes an engaging arm 510a on the Z-direction side and an engaging arm 510a on the Z′-direction side. A distance in the Z-Z′ direction between the engaging arms 510a is slightly smaller than a distance in the Z-Z′ direction from the bottom face of the lateral groove on the Z-direction side to the bottom face of the lateral groove on the Z′-direction side of the groove 711 of the molded part 700. The engaging arm 510a on the Z-direction side extends in the X direction from the end on the Z-direction side of the coupling portion 520a and includes a free end portion with a claw projecting to the Z′-direction side. Likewise, the engaging arm 510a on the Z′-direction side extends in the X direction from the end on the Z′-direction side of the coupling portion 520a and includes a free end portion with a claw projecting to the Z-direction side. The coupling portion 520a is received in the first vertical hole of the first engaging hole 112a of the housing 100. The engaging arm 510a on the Z-direction side is received from the first vertical hole of the first engaging hole 112a of the housing 100 into the first lateral hole on the Z-direction side of the first engaging hole 112a and the lateral groove on the Z-direction side of the groove 711 of the molded part 700. The claw of the engaging arm 510a on the Z-direction side is hooked on the first engaging portion 112a1 on the Z-direction side of the first engaging hole 112a. The engaging arm 510a on the Z′-direction side is received from the first vertical hole of the first engaging hole 112a of the housing 100 into the first lateral hole on the Z′-direction side of the first engaging hole 112a and the lateral groove on the Z′-direction side of the groove 711 of the molded part 700. The claw of the engaging arm 510a on the Z′-direction side is hooked on the first engaging portion 112a1 on the Z′-direction side of the first engaging hole 112a. The pair of engaging arms 510a is thus fixed to the housing 100 to elastically retain the molded part 700. The pair of engaging arms 510a may be replaced with a single engaging arm 510a.

In an embodiment, the first engaging hole 112a of the housing 100 and the retainer 500a are provided, but the groove 711 of the molded part 700 is not provided. In an embodiment, the first engaging hole 112a of the housing 100, the groove 711 of the molded part 700, and the retainer 500a are omitted. In this case, the first molded portion 710 of the molded part 700 may be fixed to the housing 100 by fitting the first molded portion 710 into the first housing space 111a of the housing 100, by engaging the engagement projection of the first molded portion 710 with an engaging hole in a wall of the first housing space 111a of the housing 100, or with other structure. Note that the structure and means for fixing the first molded portion 710 to the housing 100 are not limited to these examples.

The hybrid connector C1 further includes at least one second terminal 300b. The at least one second terminal 300b may be a single second terminal 300b (not illustrated) or a plurality of second terminals 300b (see FIGS. 1B to 1C, 2B to 2D, and. 3A to 3C). The second terminal or terminals 300b are disposed inside the housing 100 and the second connecting portion 200b. The number of the at least one second terminal 300b may be equal to, or smaller than, the number of the terminal housing portions 210b.

For convenience of description, the at least one second terminal 300b may also be hereinafter referred to as “the or each second terminal 300b”. Where a single second terminal 300b is provided, “the second terminal 300b” of “the or each second terminal 300b” means the single second terminal 300b, and where a plurality of second terminals 300b is provided, “each second terminal 300b” of “the or each second terminal 300b” means each of the second terminal 300b.

The or each second terminal 300b is constituted by an electrically conductive material, such as a metal plate, and includes a second contact portion 310b, a second body portion 320b, and a second tail 330b.

The second body portion 320b is constituted by, for example, a generally tubular plate extending in the Y-Y′ direction (see FIGS. 3A to 3C), a generally U-shaped plate extending in the Y-Y′ direction (not illustrated), a flat plate extending in the Y-Y′ direction (not illustrated), a rod extending in the Y-Y′ direction (not illustrated), or the like.

The second contact portion 310b may include a pair of beams extending in the Y direction formed by cutting out first and second walls of a generally tubular plate or a generally U-shaped plate of the second body portion 320b, or may alternatively be constituted by a single beam obtained formed by one of the first and second walls. Alternatively, the second contact portion 310b may by constituted by a pair of beams extending in the Y direction from the end on the Y-direction side of the second body portion 320b (not illustrated), a rod extending in the Y direction (not illustrated), a flat plate extending in the Y direction (not illustrated), a tube extending in the Y direction (not illustrated), or the like.

The second tail 330b is a portion on the Y′-direction side relative to the second body portion 320b, and is constituted by a flat plate, a generally tubular member, a rod, or the like extending in the Y′ direction.

The or each second terminal 300b may further include a cable retaining portion 340b. The cable retaining portion 340b is a portion on the Y′-direction side relative to the second tail 330b, and is a flat plate or generally tubular member extending in the Y′ direction.

The second body portion 320b is securely housed in the corresponding terminal housing portion 210b of the second connecting portion 200b. The second contact portion 310b is also housed in the corresponding terminal housing portion 210b of the second connecting portion 200b. The second contact portion 310b is disposed such as to be viewable from outside of the second connecting portion 200b. For example, the second contact portion 310b may be exposed from the corresponding terminal housing portion 210b in at least one of the Y direction or the Z′ direction such as to be viewable from the Y-direction side relative to the second connecting portion 200b. The second tail 330b is at least partly housed in the corresponding terminal housing portion 210b and the corresponding second housing space 111b of the housing 100. The cable retaining portion 340b may be at least partly housed in the corresponding second housing space 111b of the housing 100. Note that the cable retaining portion 340b can be omitted.

Where the second connecting portion 200b is provided with the pair of second engaging holes 230b, the hybrid connector C1 may further include a retainer 500b. The retainer 500b includes a pair of engaging arms 510b and a coupling portion 520b. The pair of engaging arms 510b includes an engaging arm 510b on the X-direction side and an engaging arm 510b on the X′-direction side. The engaging arms 510b on the X-direction side extends in the Z direction from the end on the X-direction side of the coupling portion 520b and includes a free end portion with a claw projecting to the X-direction side. The engaging arms 510b on the X′-direction side extends in the Z direction from the end on the X′-direction side of the coupling portion 520b and includes a free end portion with a claw projecting to the X′-direction side. The engaging arm 510b on the X-direction side is received in the second vertical hole of the second engaging hole 230b on the X-direction side of the second connecting portion 200b, and the claw of the engaging arm 510b on the X-direction side is received in the second lateral hole of the second engaging hole 230b on the X-direction side and hooked on the second engaging portion thereof. The engaging arm 510b on the X′-direction side is received in the second vertical hole of the second engaging hole 230b on the X′-direction side of the second connecting portion 200b, and the claw of the engaging arm 510b on the X′-direction side is received in the second lateral hole of the second engaging hole 230b on the X′-direction side and hooked on the second engaging portion thereof. The pair of engaging arms 510b is thus fixed to the second connecting portion 200b, and the coupling portion 520b abuts the second terminal or terminals 300b from the Z′-direction side. As a result, the second terminal or terminals 300b are retained between the retainer 500b and the bottom or bottoms on the Z-direction side of the terminal housing portion or portions 210b of the second connecting portion 200b.

Where the plurality of terminal housing portions 210b is provided, the retainer 500b may further include at least one partition 530b. Where the number of the plurality of terminal housing portions 210b is two, the number of the at least one partition 530b is one, and where the number of the plurality of terminal housing portions 210b is three or more, the number of the at least one partition 530b is two or more. The single partition 530b is disposed between two adjacent terminal housing portions 210b and retains the at least one second terminal 300b. Each of the two or more partitions 530b may be disposed between two adjacent ones of the terminal housing portions 210b and retains the two second terminals 300b housed in the two adjacent terminal housing portions 210b.

The at least one partition 530b can be omitted. Also, the pair of second engaging holes 230b of the second connecting portion 200b and the retainer 500b can be omitted.

The hybrid connector C1 may further include at least one second cable 600b. The at least one second cable 600b may be a single cable or a plurality of cables in accordance with the number of the at least one second terminal 300b.

For convenience of description, the at least one second cable 600b may also be hereinafter referred to as “the or each second cable 600b”. Where a single second cable 600b is provided, “the second cable 600b” of the “the or each second cable 600b” means the single second cable 600b, and where a plurality of second cables 600b is provided, “each second cable 600b” of “the or each second cable 600b” means each of the second cables 600b.

The or each second cable 600b includes a sheath 610b and a wire 620b. The sheath 610b is a generally tubular member constituted by an insulating material. The wire 620b is constituted by an electrically conductive material and disposed inside the sheath 610b. The sheath 610b includes a distal portion on the Y-direction side, and the wire 620b includes a distal portion on the Y- direction side protruding from the distal portion of the sheath 610b. The distal portions of the wire 620b and the sheath 610b are received from the Y′-direction side into the corresponding the second housing space 111b of housing 100, and the distal portion of the wire 620b is connected to the second tail 330b of the corresponding second terminal 300b. Where the corresponding second terminal 300b is provided with the cable retaining portion 340b, the distal portion of the sheath 610b is retained by the cable retaining portion 340b of the corresponding second terminal 300b.

A method for manufacturing the hybrid connector C1 will now be described. The manufacturing method includes a method of manufacturing a first assembly, a method of manufacturing a second assembly, and a method of assembling the first assembly and the second assembly together.

A non-limiting manufacturing method of the first assembly will now be described. First, the first terminal 300a and the first cable 600a are prepared. The distal portion of the inner conductor 640a of the first cable 600a is connected to the first tail 330a of the first terminal 300a by crimping, pressure welding, soldering, or other means. Thereafter, the first connecting portion 200a and the body 400 are prepared. With the second housing portion 412 of the terminal housing portion 410 of the body 400 directed in the Y′ direction, the body 400 is inserted into the first connecting portion 200a from the Y-direction side, and the body 400 is brought into abutment with the abutment 231a of the first connecting portion 200a. The body 400 is then temporarily fixed inside the first connecting portion 200a using a jig or the like. Thereafter, with the first contact portion 310 of the first terminal 300a directed to the Y-direction side, the first terminal 300a is inserted from the Y′-direction side into the first connecting portion 200a, through the abutment 231a, and then into the terminal housing portion 410 of the body 400. The first terminal 300a is thus retained inside the terminal housing portion 410 of the body 400. At the same time, the distal portion of the inner conductor 640a of the first cable 600a connected to the first terminal 300a is inserted from the Y′-direction side into the first connecting portion 200a and then into the terminal housing portion 410 of the body 400, the distal portion of the inner insulator 630a of the first cable 600a and a part of the distal portion of the outer conductor 620a of the first cable 600a are inserted from the Y′-direction side into the first connecting portion 200a, and the distal portion of the outer conductor 620a of the first cable 600a is brought into contact with the rear portion 230a of the first connecting portion 200a, directly or indirectly via the conductive ring 800. The distal portion of the outer conductor 620a of the first cable 600a is thereby electrically connected to the rear portion 230a of the first connecting portion 200a. Thereafter, the rear portion 230a of the first connecting portion 200a is swaged from outside or subjected to a like processing, so that the first cable 600a is retained by the rear portion 230a of the first connecting portion 200a, together with the conductive ring 800 (if provided). Where the molded part 700 is provided, the molded part 700 is molded, by overmolding or the like means, around a portion of the rear portion 230a of the first connecting portion 200a and a portion of the first cable 600a that are located on the Y′-direction side relative to the rear portion 230a of the first connecting portion 200a. The first cable 600a is thereby fixed to the first connecting portion 200a. In this way, the first assembly is manufactured.

A non-limiting manufacturing method of the second assembly will now be described. All the steps of the manufacture of the second assembly may be performed before or after the manufacture of the first assembly. Alternatively, some of the steps of the manufacture of the second assembly may be performed before the manufacture of the first assembly and the remaining steps may be performed after the manufacture of the first assembly.

First, the at least one second terminal 300b and the at least one second cable 600b are prepared. The distal portion of the wire 620b of the or each second cable 600b is connected to the second tail 330b of the corresponding second terminal 300b by crimping, pressure welding, soldering, or other means. Where the corresponding second terminal 300b is provided with the cable retaining portion 340b, the distal portion of the sheath 610b of the or each second cable 600b is retained by the cable retaining portion 340b of the corresponding second terminal 300b. Thereafter, the housing 100, the second connecting portion 200b, and the at least one anti-misinsertion projection 220b are prepared by molding a synthetic resin. The distal portion of the wire 620b of the or each second cable 600b, the distal portion of the sheath 610b of the or each second cable 600b, and the corresponding second terminal 300b are housed in the corresponding terminal housing portion 210b of the second connecting portion 200b and the corresponding second housing space 111b of the housing 100. The second body portion 320b of the or each second terminal 300b is thus retained inside the corresponding terminal housing portion 210b of the second connecting portion 200b. Where the retainer 500b is provided, the pair of engaging arms 510b of the retainer 500b is inserted from the Z′-direction side into the second vertical holes of the pair of second engaging holes 230b of the second connecting portion 200b, and the claws of the engaging arms 510b are hooked on the second engaging portions of the second engaging holes 230b. The or each second terminal 300b is thus retained between the retainer 500b and the second connecting portion 200b. By retaining the or each second terminal 300b in this manner, the corresponding second cable 600b is attached to the second connecting portion 200b via the or each second terminal 300b. Where the retainer 500b is not provided, the step of inserting the retainer 500b is omitted. In this way, the second assembly is manufactured.

A method of assembling the first assembly and the second assembly together will now be described. The protruding portion 210a of the first connecting portion 200a of the first assembly is inserted from the Y′-direction side into the first housing space 111a of the first body portion 110a of the housing 100 of the second assembly so as to protrude in the Y direction from the first housing space 111a and the tube 120 (if provided), and the first molded portion 710 of the molded part 700 is inserted from the Y′-direction side fittingly into the first housing space 111a. Where the retainer 500a is provided, the retainer 500a is inserted from the X-direction side into the first engaging hole 112a of the first body portion 110a of the housing 100 to fix the pair of engaging arms 510a of the retainer 500a to the housing 100 and fix the molded part 700 to the housing 100. Where the retainer 500a is not provided, the step of inserting the retainer 500a is omitted. In this manner, the first assembly is combined with the second assembly to manufacture the hybrid connector C1.

The hybrid connector C1 described above provides the following technical features and effects (1) to (5).

### Technical Feature and Effect (1)

The hybrid connector C1 is configured such that the first connecting portion 200a and the second connecting portion 200b arranged in spaced relation to each other in the Z-Z′ direction, and that the at least one anti-misinsertion projection 220b is provided at the second connecting portion 200b such as to project in the Z′ direction and is disposed between the first connecting portion 200a and the second connecting portion 200b. This results in a novel hybrid connector C1 having at least one anti-misinsertion projection 220b is provided.

### Technical Feature and Effect (2)

In the hybrid connector C1, the provision of the at least one anti-misinsertion projection 220b affects the upsizing of the hybrid connector C1 to a lesser degree, for the reasons to be described comparing with the conventional example. The hybrid connector of the conventional example is configured such that the first and second anti-misinsertion projections extend from the protruding portion in the X and X′ directions, respectively. This causes increase in the sum of the dimensions in the X-X′ direction of the protruding portion, the first anti-misinsertion projection, and the second anti-misinsertion projection, resulting in the increased dimension in the X-X′ direction of the hybrid connector of the conventional example. On the other hand, the hybrid connector C1 is configured such that the first connecting portion 200a and the second connecting portion 200b are arranged in spaced relation to each other in the Z-Z′ direction, and that the at least one anti-misinsertion projection 220b is provided at the second connecting portion 200b such as to project in the Z′ direction and is disposed between the first connecting portion 200a and the second connecting portion 200b. Therefore, the provision of the at least one anti-misinsertion projection 220b affects the increase in the dimension in the X-X′ direction of the hybrid connector C1 to a lesser degree.

Moreover, where the at least one anti-misinsertion projection 220b projects toward the at least one second portion 122 of the tube 120 and/or the at least one second portion 212a of the first connecting portion 200a, the provision of the at least one anti-misinsertion projection 220b affects the increase in the dimension in the Z-Z′ direction of the hybrid connector C1 to a lesser degree for the reason below. The linear distance d1 in the Z-Z′ direction between the single second portion 122 and the second connecting portion 200b, or alternatively each linear distance d1 in the Z-Z′ direction between each of the second portions 122 and the second connecting portion 200b, is larger than the linear distance d2 in the Z-Z′ direction between the first portion 121 and the second connecting portion 200b, and/or the linear distance d3 in the Z-Z′ direction between the single second portion 212a and the second connecting portion 200b, or alternatively each linear distance d3 in the Z-Z′ direction between each of the second portion 212a and the second connecting portion 200b, is larger than the linear distance d4 in the Z-Z′ direction between the first portion 211a and the second connecting portion 200b. Because of such distance relationship, by configuring the at least one anti-misinsertion projection 220b such as to protrude toward the at least one second portion 122 of the tube 120 and/or the at least one second portion 212a of the first connecting portion 200a, it is possible to decrease the distance in the Z-Z′ direction from the at least one anti-misinsertion projection 220b to the tube 120 and/or to the first connecting portion 200a. As a result, the provision of the at least one anti-misinsertion projection 220b affects the increase in the distance in the Z-Z′ direction between the second connecting portion 200b and the first connecting portion 200a to a lesser degree.

### Technical Feature and Effect (3)

The second connecting portion 200b of the hybrid connector C1 is increased in strength because the second connecting portion 200b is provided with the at least one anti-misinsertion projection 220b. Where the hybrid connector C1 is provided with the lock portion 200c, the lock portion 200c, which is located on the Z-direction side relative to the second connecting portion 200b, is subjected to a load from the Z-direction side when locked and unlocked (to be described). However, the second connecting portion 200b is reinforced with the at least one anti-misinsertion projection 220b, and therefore the second connecting portion 200b is able to withstand the load.

### Technical Feature and Effect (4)

Even where the hybrid connector C1 is provided with the lock portion 200c, the provision of the lock portion 200c affects the increase in the dimension in the Y-Y′ direction of the hybrid connector C1 to a lesser degree for the reason below. The proximal portion 210c of the lock portion 200c rises from the distal portion of the second connecting portion 200b of the housing 100 to the Z-direction side. That is, the proximal portion 210c of the lock portion 200c is disposed on the Y-direction side relative to the first end face of the first body portion 110a and the tube 120 (if provided) of the housing 100. The arm 220c of the lock portion 200c extends from the proximal portion 210c in the Y′ direction beyond the first end face of the first body portion 110a of the housing 100. This arrangement allows ensuring the necessary dimension in the Y-Y′ direction of the lock portion 200c, and this dimension is advantageously equal to, or smaller than, the sum of the dimensions in the Y-Y′ direction of the second connecting portion 200b and the second body portion 110b of the housing 100. Therefore, the provision of the lock portion 200c affects the increase in the dimension in the Y-Y′ direction of the hybrid connector C1 to a lesser degree.

### Technical Feature and Effect (5)

Where the retainer 500b is provided, the retainer 500b and the second connecting portion 200b can retain the at least one second terminal 300b by attaching the retainer 500b to the second connecting portion 200b before the first assembly is combined with the second assembly, i.e., before the protruding portion 210a of the first connecting portion 200a protrudes from the housing 100 of the second assembly in the Y direction. Furthermore, since the retainer 500b is structured such as to be attachable to the second connecting portion 200b from the Z′-direction side, this structure allows decrease of the dimension in the Z-Z′ direction of the second connecting portion 200b, as compared with a structure in which the retainer 500b is attached to the second connecting portion 200b from the X- or the X′-direction side.

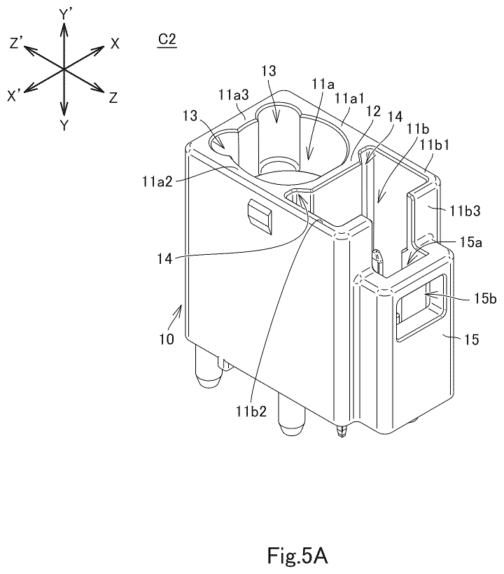

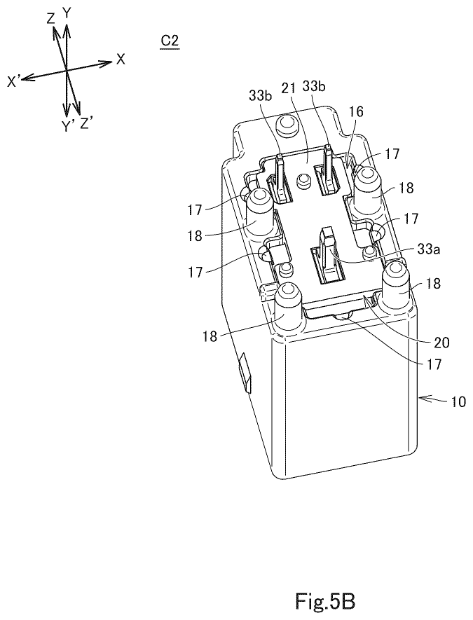

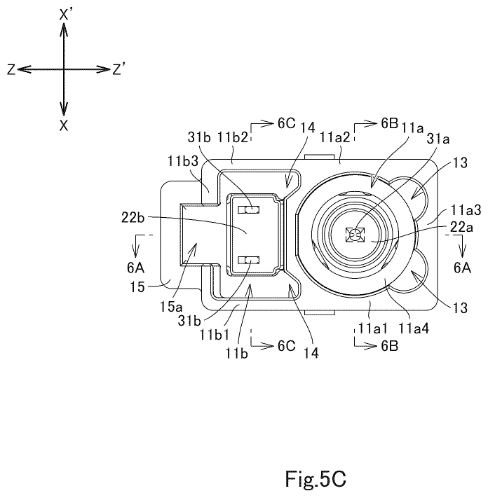

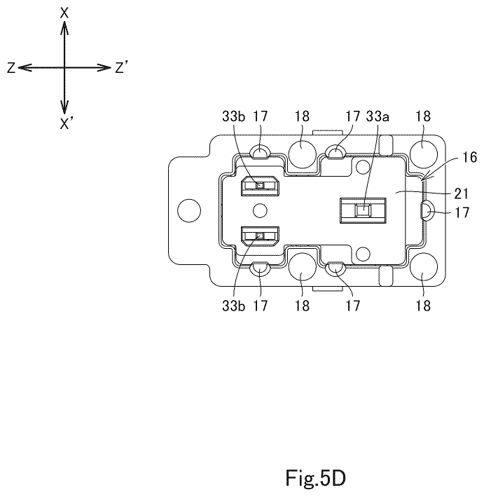

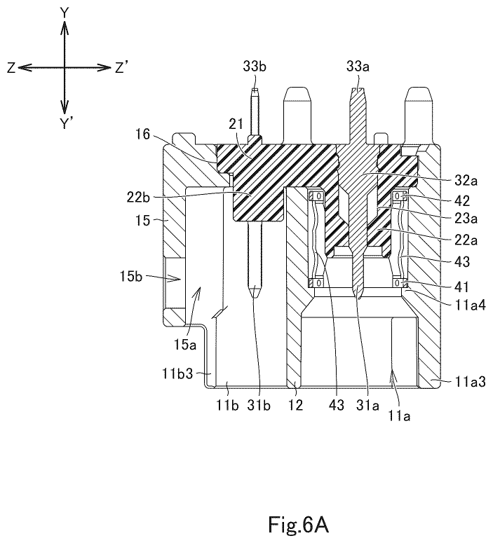

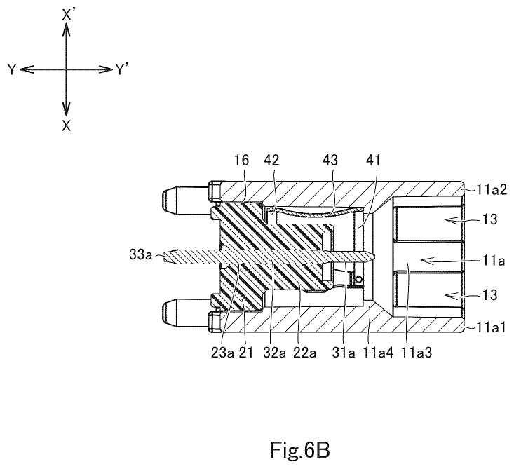

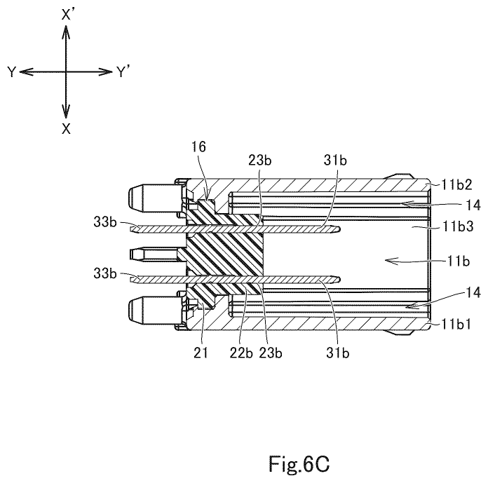

A hybrid connector C2 (second hybrid connector) according to a plurality of embodiments of the invention, including the first embodiment and its variants, will now be described with reference to FIGS. 5A to 7B. FIGS. 5A to 7B illustrate the hybrid connector C2 of the first embodiment. FIGS. 5A, 5B, and 6A to 7B also show the Y-Y′ direction, FIGS. 5A to 6A, 7A, and 7B also show the Z-Z′ direction, and FIGS. 5A to 5D and 6B to 7B also show the X-X′ direction.

The hybrid connector C2 includes a shell 10. The shell 10 may be constituted by an electrically conductive material (e.g., a metal or a carbon material such as a carbon nanotube). For example, the shell 10 may be constituted by a cast metal or constituted by an electrically conductive material fabricated by a 3D printer. Alternatively, the shell 10 may include a shell body, which is constituted by an insulating material, and a metal film plated or deposited on a surface of the shell body.

The shell 10 includes a first connecting hole 11a, a second connecting hole 11b, a bounding wall 12, a first wall 11a1, a second wall 11a2, a third wall 11a3, a fourth wall 11b1, a fifth wall 11b2, and a sixth wall 11b3.

The first connecting hole 11a is provided in the shell 10, extends in the Y-Y′ direction, and opens in the Y′ direction. The second connecting hole 11b is provided in the shell 10, extends in the Y-Y′ direction, and opens in the Y′ direction. The second connecting hole 11b is disposed on the Z-direction side relative to, and in spaced relation to, the first connecting hole 11a.

The bounding wall 12 is a wall between the first connecting hole 11a and the second connecting hole 11b of the shell 10. Accordingly, the bounding wall 12 is located on the Z-direction side relative to the first connecting hole 11a and is located on the Z′-direction side relative to the second connecting hole 11b. The first wall 11a1 is located on the X-direction side relative to the first connecting hole 11a. The second wall 11a2 is located on the X′-direction side relative to the first connecting hole 11a. The third wall 11a3 is located on the Z′-direction side relative to the first connecting hole 11a. The fourth wall 11b1 is located on the X-direction side relative to the second connecting hole 11b. The fifth wall 11b2 is located on the X′-direction side relative to the second connecting hole 11b. The sixth wall 11b3 is located on the Z-direction side relative to the second connecting hole 11b. The bounding wall 12, the first wall 11a1, the second wall 11a2, and the third wall 11a3 define the first connecting hole 11a. The bounding wall 12, the fourth wall 11b1, the fifth wall 11b2, and the sixth wall 11b3 define the second connecting hole 11b.

The shell 10 may further include at least one step 11a4. The at least one step 11a4 is provided at at least one of the bounding wall 12, the first wall 11a1, the second wall 11a2, or the third wall 11a3. For example, the bounding wall 12, the first wall 11a1, the second wall 11a2, and the third wall 11a3 may be provided with a generally ring-shaped step 11a4 projecting toward the central axis the first connecting hole 11a (to inside the first connecting hole 11a) and being positioned in the first connecting hole 11a (see FIG. 5C). Alternatively, each of the bounding wall 12, the first wall 11a1, the second wall 11a2, and the third wall 11a3 may be provided with at least one step 11a4 projecting toward the central axis of the first connecting hole 11a and being positioned in the first connecting hole 11a (not illustrated). In the former case, the single step 11a4 is provided, and in the latter case, the at least four steps 11a4 are provided. The single or at least four steps 11a4 serve to partition the first connecting hole 11a into a space on the Y-direction side and a space on the Y′-direction side.

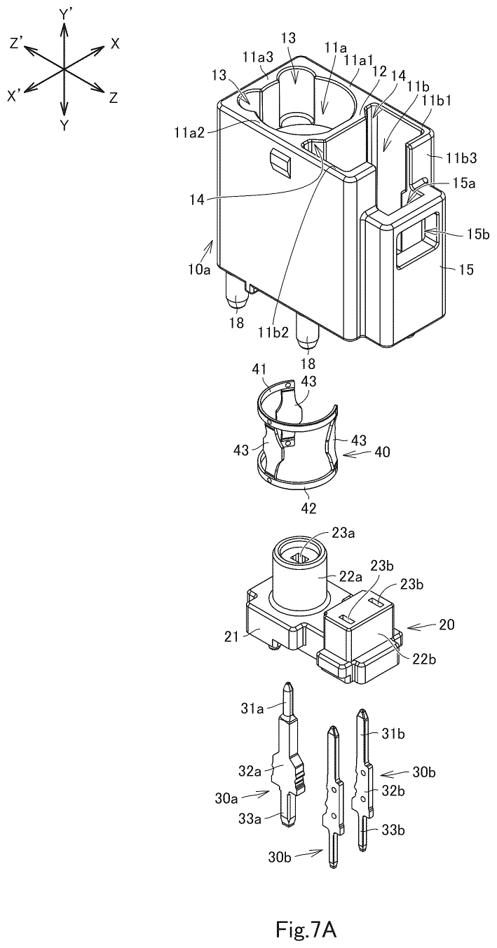

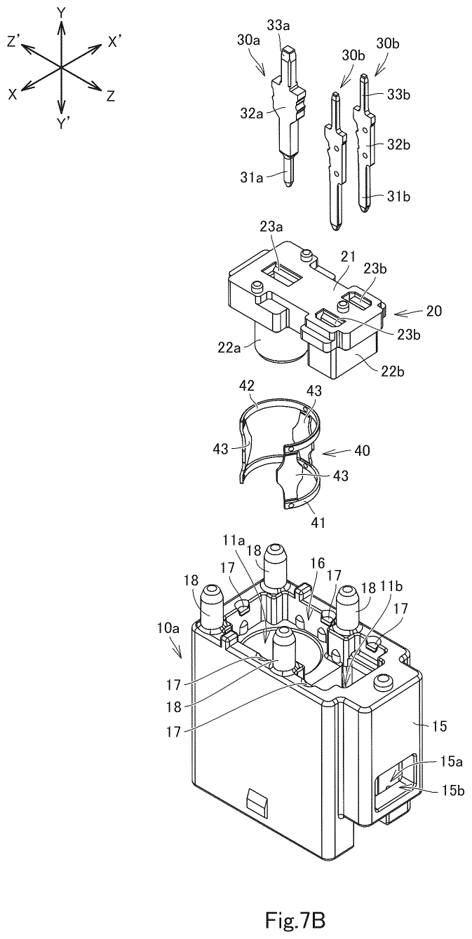

The shell 10 further includes at least one anti-misinsertion recess 14. The at least one anti-misinsertion recess 14 is a single recess (not illustrated) or a plurality of recesses (see FIGS. 5A, 5C, and 7A) in accordance with the number of the at least one anti-misinsertion projection 220b of the hybrid connector C1.

For convenience of description, the at least one anti-misinsertion recess 14 may also be hereinafter referred to as “the or each anti-misinsertion recess 14”. Where a single anti-misinsertion recess 14 is provided, “the anti-misinsertion recess 14” of the “the or each anti-misinsertion recess 14” means the single anti-misinsertion recess 14, and where a plurality of anti-misinsertion recesses 14 is provided, “each anti-misinsertion recess 14” of “the or each anti-misinsertion recess 14” means each of the anti-misinsertion recesses 14.

The or each anti-misinsertion recess 14 is provided in the bounding wall 12, extends in the Y-Y′ direction, extends from the second connecting hole 11b in the Z′ direction, opens in the Y′ direction, and communicates with the second connecting hole 11b. The or each anti-misinsertion recess 14 does not communicate with the first connecting hole 11a.

In a case where the tube 120 of the hybrid connector C1 is provided and the single or at least four steps 11a4 of the hybrid connector C2 are provided, the space on the Y′-direction side of the first connecting hole 11a has a shape and dimensions that correspond to an outer shape and outer dimensions, respectively, of the tube 120 of the hybrid connector C1. Additionally, in this case, the single step 11a4 has an inner shape and inner dimensions in a cross section along the Z-Z′ and X-X′ directions that correspond to an outer shape and outer dimensions, respectively, in a cross section along the Z-Z′ and X-X′ directions of the protruding portion 210a of the first connecting portion 200a of the hybrid connector C1, or alternatively the at least four steps 11a4 define a space having a shape and dimensions in a cross section along the Z-Z′ and X-X′ directions that correspond to the outer shape and the outer dimensions, respectively, in the cross section along the Z-Z′ and X-X′ directions of the protruding portion 210a of the first connecting portion 200a of the hybrid connector C1. The protruding portion 210a of the first connecting portion 200a and the tube 120 of the hybrid connector C1 is removably receivable into the first connecting hole 11a along the Y-Y′ direction, and the protruding portion 210a is removably receivable into the single step 11a4, or in between the at least four steps 11a4, along the Y-Y′ direction. With the protruding portion 210a of the first connecting portion 200a of the hybrid connector C1 received in the first connecting hole 11a, the tube 120 of the hybrid connector C1 fits in the space on the Y′-direction side of the first connecting hole 11a, while the single or the at least four steps 11a4 contactingly fit over the protruding portion 210a of the first connecting portion 200a of the hybrid connector C1, or alternatively face the protruding portion 210a with a slight gap therebetween.

In a case where the tube 120 of the hybrid connector C1 is provided but the single or at least four steps 11a4 of the hybrid connector C2 are not provided, the first connecting hole 11a has a shape and dimensions in a cross section along the Z-Z′ and X-X′ directions that correspond to the outer shape and the outer dimensions, respectively, in the cross section along the Z-Z′ and X-X′ directions of the tube 120 of the hybrid connector C1. The protruding portion 210a of the first connecting portion 200a and the tube 120 of the hybrid connector C1 are removably receivable into the first connecting hole 11a along the Y-Y′ direction. With the protruding portion 210a of the first connecting portion 200a of the hybrid connector C1 received in the first connecting hole 11a, the tube 120 of the hybrid connector C1 fits in the first connecting hole 11a.

In a case where the housing 100 of the hybrid connector C1 is not provided with the tube 120 but the single or at least four steps 11a4 of the hybrid connector C2 are provided, the dimensions in the cross section along the Z-Z′ and X-X′ directions of the first connecting hole 11a are larger than outer dimensions in the cross section along the Z-Z′ and X-X′ directions of the first connecting portion 200a of the hybrid connector C1. Additionally, in this case, the inner shape and the inner dimensions in the cross section along the Z-Z′ and X-X′ directions of the single step 11a4 are as described above, or alternatively the shape and the dimensions in the cross section along the Z-Z′ and X-X′ directions of the space defined by the at least four steps 11a4 are as described above. The protruding portion 210a of the first connecting portion 200a of the hybrid connector C1 is removably receivable into the first connecting hole 11a along the Y-Y′ direction, and the protruding portion 210a is removably receivable into the single step 11a4, or in between the at least four steps 11a4, along the Y-Y′ direction. With the protruding portion 210a of the first connecting portion 200a of the hybrid connector C1 received in the first connecting hole 11a, the single or at least four steps 11a4 contactingly fit over the protruding portion 210a of the first connecting portion 200a of the hybrid connector C1, or alternatively face the protruding portion 210a with a slight gap therebetween.

In a case where the housing 100 of the hybrid connector C1 is not provided with the tube 120 and the single or at least four steps 11a4 of the hybrid connector C2 are not provided, the dimensions in the cross section along the Z-Z′ and X-X′ directions of the first connecting hole 11a are larger than the outer dimensions in the cross section along the Z-Z′ and X-X′ directions of the first connecting portion 200a of the hybrid connector C1, or alternatively the shape and the dimensions in the cross section along the Z-Z′ and X-X′ directions of the first connecting hole 11a correspond to an outer shape and the outer dimensions, respectively, in the cross section along the Z-Z′ and X-X′ directions of the first connecting portion 200a of the hybrid connector C1. The protruding portion 210a of the first connecting portion 200a of the hybrid connector C1 is removably receivable into the first connecting hole 11a along the Y-Y′ direction.

The second connecting hole 11b has a shape and dimensions in a cross section along the Z-Z′ and X-X′ directions that correspond to an outer shape and outer dimensions, respectively, in a cross section along the Z-Z′ and X-X′ directions of the second connecting portion 200b of the hybrid connector C1. The second connecting portion 200b of the hybrid connector C1 can be inserted into and removed from the second connecting hole 11b in the Y-Y′ direction. The second connecting portion 200b of the hybrid connector C1 is fitted into the second connecting hole 11b in a state where the second connecting portion 200b of the hybrid connector C1 is inserted into the second connecting hole 11b.

The or each anti-misinsertion recess 14 has a shape and dimensions in a cross section along the Z-Z′ and X-X′ directions that correspond to an outer shape and outer dimensions, respectively, in a cross section along the Z-Z′ and X-X′ directions of the corresponding anti-misinsertion projection 220b. The corresponding anti-misinsertion projection 220b removably receivable into the or each anti-misinsertion recess 14 along the Y-Y′ direction. With the second connecting portion 200b of the hybrid connector C1 received in the second connecting hole 11b, the corresponding anti-misinsertion projection 220b of the hybrid connector C1 fits in the or each anti-misinsertion recess 14.

The bounding wall 12 includes a central portion having an outer shape and outer dimensions in a cross section along the Z-Z′ and X-X′ directions that correspond to a shape and dimensions, respectively, in a cross section along the Z-Z′ and X-X′ directions of the gap G of the hybrid connector C1. The central portion of the bounding wall 12 is removably receivable into the gap G of the hybrid connector C1 along the Y-Y′ direction.

As used hereinafter the term “directly facing state” means a state where, in the Y-Y′ direction, the first connecting portion 200a and the second connecting portion 200b of the hybrid connector C1 face the first connecting hole 11a and the second connecting hole 11b, respectively, of the shell 10 of the hybrid connector C2, the or each anti-misinsertion projection 220b of the hybrid connector C1 faces the corresponding anti-misinsertion recess 14 of the hybrid connector C2, and the bounding wall 12 of the hybrid connector C2 faces the gap G between the first connecting portion 200a, and the second connecting portion 200b and the at least one anti-misinsertion projection 220b of the hybrid connector C1.

Where the single or at least four steps 11a4 are provided, at least one of the following linear distances d6, d7 or d8 is larger than a shortest linear distance d5 in the Z-Z′ direction from the or each anti-misinsertion projection 220b to the protruding portion 210a of the first connecting portion 200a of the hybrid connector C1 in the directly facing state (see FIG. 1C). The linear distance d6 is a linear distance in the X-X′ direction from the outer face on the X-direction side of the first wall 11a1 to the inner edge of the single step 11a4, or to the end on the X′-direction side of the step 11a4 on the first wall 11a1 of the at least four steps 11a4. The linear distance d7 is a linear distance in the X-X′ direction from the outer face on the X′-direction side of the second wall 11a2 to the inner edge of the single step 11a4, or to the end on the X-direction side of the step 11a4 on the second wall 11a2 of the at least four steps 11a4. The linear distance d8 is a linear distance in the Z-Z′ direction from the outer face on the Z′-direction side of the third wall 11a3 to the inner edge of the single step 11a4, or to the end on the Z-direction side of the step 11a4 on the third wall 11a3 of the at least four steps 11a4. In any of these cases, at least one of one of the following linear distances d9, d10 or d11 may be smaller than, equal to, or larger than, the shortest linear distance d5. The linear distance d9 is a linear distance in the X-X′ direction from the outer face on the X-direction side to the inner face on the X′-direction side of at least a part of the first wall 11a1. The linear distance d10 is a linear distance in the X-X′ direction from the outer face on the X′-direction side to the inner face on the X-direction side of at least a part of the second wall 11a2. The linear distance d11 is a linear distance in the Z-Z′ direction from the outer face on the Z′-direction side to the inner face on the Z-direction side of at least a part of the third wall 11a3. Where the protruding portion 210a of the first connecting portion 200a includes the first portion 211a and the at least one second portion 212a, the shortest linear distance d5 is the shortest linear distance in the Z-Z′ direction from the or each anti-misinsertion projection 220b of the hybrid connector C1 to the first portion 211a of the protruding portion 210a of the first connecting portion 200a in the directly facing state.

Where the single or at least four steps 11a4 are not provided, at least one of the linear distances d9, d10 or d11 is larger than the shortest linear distance d5 in the directly facing state.

At least one of the following linear distances d12, d13 or d14 may be smaller than, equal to, or larger than, the shortest linear distance d5 in the directly facing state. The linear distance d12 is a linear distance in the X-X′ direction from the outer face on the X-direction side to the inner face on the X′-direction side of at least a part of the fourth wall 11b1. The linear distance d13 is a linear distance in the X-X′ direction from the outer face on the X′-direction side to the inner face on the X-direction side of at least a part of the fifth wall 11b2. The linear distance d14 is a linear distance in the Z-Z′ direction from the outer face on the Z-direction side to the inner face on the Z′-direction side of at least a part of the sixth wall 11b3.

The hybrid connector C1 and the hybrid connector C2 may face each other not in the directly facing state but in one of the following first to eighth non-directly facing states in the Y-Y′ direction.

The first non-directly facing state is a state where the first connecting portion 200a of the hybrid connector C1 faces the second connecting hole 11b of the hybrid connector C2, the second connecting portion 200b of the hybrid connector C1 faces the first connecting hole 11a of the hybrid connector C2 and the bounding wall 12 of the hybrid connector C2 faces the gap G of the first connecting portion 200a of the hybrid connector C1 in the Y-Y′ direction. In other words, this is a state where the outer shape in the cross section along the Z-Z′ and X-X′ directions of the central portion of the bounding wall 12 of the hybrid connector C2 is inverted in the Z-Z′ direction relative to the shape in the cross section along the Z-Z′ and X-X′ directions of the gap G of the hybrid connector C1.

The second non-directly facing state is a state where, with the hybrid connector C1 rotated clockwise by about 90 degrees from the directly facing state about the central axis of the first connecting portion 200a, the first connecting portion 200a of the hybrid connector C1 faces the first connecting hole 11a of the hybrid connector C2, and the gap G of the hybrid connector C1 faces the first wall 11a1 of the first connecting hole 11a of the hybrid connector C2 in the Y-Y′ direction.

The third non-directly facing state is a state where, with the hybrid connector C1 rotated counterclockwise by about 90 degrees from the directly facing state about the central axis of the first connecting portion 200a, the first connecting portion 200a of the hybrid connector C1 faces the first connecting hole 11a of the hybrid connector C2, and the gap G of the hybrid connector C1 faces the second wall 11a2 of the first connecting hole 11a of the hybrid connector C2 in the Y-Y′ direction.

The fourth non-directly facing state is a state where, with the hybrid connector C1 rotated clockwise or counterclockwise by about 180 degrees from the directly facing state about the central axis of the first connecting portion 200a, the first connecting portion 200a of the hybrid connector C1 faces the first connecting hole 11a of the hybrid connector C2 and the gap G of the hybrid connector C1 faces the third wall 11a3 of the first connecting hole 11a of the hybrid connector C2 in the Y-Y′ direction.

The fifth non-directly facing state is a state where, with the hybrid connector C1 rotated clockwise by about 90 degrees from the directly facing state about the central axis of the second connecting portion 200b, the second connecting portion 200b of the hybrid connector C1 faces the second connecting hole 11b of the hybrid connector C2 and the gap G of the hybrid connector C1 faces the fourth wall 11b1 of the second connecting hole 11b of the hybrid connector C2 in the Y-Y′ direction.

The sixth non-directly facing state is a state where, with the hybrid connector C1 rotated counterclockwise by about 90 degrees from the directly facing state about the central axis of the second connecting portion 200b, the second connecting portion 200b of the hybrid connector C1 faces the second connecting hole 11b of the hybrid connector C2 and the gap G of the hybrid connector C1 faces the fifth wall 11b2 of the second connecting hole 11b of the hybrid connector C2 in the Y-Y′ direction.

The seventh non-directly facing state is a state where, with the hybrid connector C1 rotated clockwise or counterclockwise by about 180 degrees from the directly facing state about the central axis of the second connecting portion 200b, the second connecting portion 200b of the hybrid connector C1 faces the second connecting hole 11b of the hybrid connector C2 and the gap G of the hybrid connector C1 faces the sixth wall 11b3 of the second connecting hole 11b of the hybrid connector C2 in the Y-Y′ direction.

The eighth non-directly facing state is a state where the protruding portion 210a of the first connecting portion 200a of the hybrid connector C1 faces the second connecting hole 11b of the hybrid connector C2 and the second connecting portion 200b of the hybrid connector C1 faces a lock portion 15 (if provided, to be described) of the hybrid connector C2 in the Y-Y′ direction.

In the second, third, fifth, and sixth non-directly facing states, the shortest linear distance d5 of the hybrid connector C1 is the shortest linear distance in the X-X′ direction from the or each anti-misinsertion projection 220b of the hybrid connector C1 to the protruding portion 210a (the first portion 211a of the protruding portion 210a if the first portion 211a is provided) of the first connecting portion 200a. In the first, fourth, seventh, and eighth non-directly facing states, the shortest linear distance d5 of the hybrid connector C1 remains the shortest linear distance in the Z-Z′ direction from the or each anti-misinsertion projection 220b of the hybrid connector C1 to the protruding portion 210a (the first portion 211a of the protruding portion 210a if the first portion 211a is provided) of the first connecting portion 200a.

Where the at least one first keying projection 130 of the hybrid connector C1 is provided, the shell 10 further includes at least one first keying recess 13. The at least one first keying recess 13 is a single recess (not illustrated) or a plurality of recesses (see FIGS. 5A, 5C, and 7A) in accordance with the number of the at least one first keying projection 130.

For convenience of description, the at least one first keying recess 13 may also be hereinafter referred to as “the or each first keying recess 13”. Where a single first keying recess 13 is provided, “the first keying recess 13” of the “the or each first keying recess 13” means the single first keying recess 13, and where a plurality of first keying recesses 13 is provided, “each first keying recess 13” of “the or each first keying recess 13” means each of the first keying recesses 13.

The or each first keying recess 13 is provided in the first wall 11a1, the second wall 11a2, or the third wall 11a3 of the first connecting hole 11a, extends in the Y-Y′ direction, opens in the Y′ direction, and communicates with the first connecting hole 11a. The or each first keying recess 13 has a shape and dimensions in a cross section along the Z-Z′ and X-X′ directions that correspond to an outer shape and outer dimensions, respectively, in a cross section along the Z-Z′ and X-X′ directions of the corresponding first keying projection 130. The corresponding first keying projection 130 of the hybrid connector C1 removably receivable into the or each first keying recess 13 along the Y-Y′ direction. Where the at least one first keying projection 130 of the hybrid connector C1 is not provided, the at least one first keying recess 13 may or may not be provided.

Where the at least one second keying projection of the hybrid connector C1 is provided, the shell 10 further includes at least one second keying recess (not illustrated). The at least one second keying recess may be a single recess or a plurality of recesses in accordance with the number of the at least one second keying projection.

For convenience of description, the at least one second keying recess may also be hereinafter referred to as “the or each second keying recess”. Where a single second keying recess is provided, “the second keying recess” of the “the or each second keying recess” means the single second keying recess, and where a plurality of second keying recess is provided, “each second keying recess” of “the or each second keying recess” means each of the second keying recesses.

The or each second keying recess is provided in the fourth wall 11b1 or the fifth wall 11b2 of the second connecting hole 11b, extends in the Y-Y′ direction, opens in the Y′ direction, and communicates with the second connecting hole 11b. The or each second keying recess has a shape and dimensions in a cross section along the Z-Z′ and X-X′ directions that correspond to an outer shape and outer dimensions, respectively, in a cross section along the Z-Z′ and X-X′ directions of the corresponding second keying projection. The corresponding second keying projection of the hybrid connector C1 is removably receivable into the or each second keying recess along the Y-Y′ direction. Where the at least one second keying projection of the hybrid connector C1 is not provided, the at least one second keying projection may or may not be provided.

Where the lock portion 200c of the hybrid connector C1 is provided, the shell 10 further includes a lock portion 15. The lock portion 15 is a box that is provided at the sixth wall 11b3 of the shell 10 such as to project to the Z-direction side and extends in the Y-Y′ direction. The lock portion 15 is provided with a guide hole 15a extending in the Y-Y′ direction and opening in the Y′ direction. The guide hole 15a extends through the sixth wall 11b3 of the shell 10 in the Z-Z′ direction and communicates with the second connecting hole 11b. The proximal portion 210c, the arm 220c, and the lock projection 230c of the lock portion 200c of the hybrid connector C1 are removably receivable into the guide hole 15a. The guide hole 15a has a shape and dimensions in a cross section along the Z-Z′ and X-X′ directions that correspond to an outer shape and outer dimensions, respectively, in a cross section along the Z-Z′ and X-X′ directions of the proximal portion 210c and the arm 220c of the lock portion 200c. The lock portion 15 includes a wall on the Z-direction side relative to the guide hole 15a, and this wall is provided with a lock hole 15b. The lock hole 15b extends from the guide hole 15a in the Z direction, communicates with the guide hole 15a, and opens in the Z direction. When the proximal portion 210c, the arm 220c, and the lock projection 230c of the lock portion 200c of the hybrid connector C1 are inserted into the guide hole 15a from the Y′-direction side to bring the lock projection 230c into abutment with a portion on the Y′-direction side relative to the lock hole 15b, the lock projection 230c is subjected to a load from the Z-direction side, and the arm 220c is elastically deformed to the Z′-direction side. When the lock projection 230c moves over the portion on the Y′-direction side relative to the lock hole 15b, the arm 220c restores itself and the lock projection 230c is fitted into the lock hole 15b. The lock projection 230c is thus locked to the lock hole 15b. When the lock projection 230c in locked state of the lock portion 200c of the hybrid connector C1 is subjected to a load from the Z-direction side, the fitting (locking) between the lock projection 230c of the lock portion 200c and the lock hole 15b of the lock portion 15 of the hybrid connector C2 is released. In this manner, the lock portion 200c of the hybrid connector C1 is subjected to a load from the Z-direction side when locked and unlocked. Where the lock portion 200c of the hybrid connector C1 is not provided, the lock portion 15 is omitted.

The shell 10 further includes a housing hole 16. The housing hole 16 is provided in a portion of the shell 10 that is located on the Y-direction side relative to the first connecting hole 11a and the second connecting hole 11b, and opens in the Y direction. The housing hole 16 communicates with the first connecting hole 11a and the second connecting hole 11b.

The shell 10 may further include a plurality of swaged portions 17 provided at an edge portion on the Y-direction side of the housing hole 16 of the shell 10. The plurality of swaged portions 17 is formed by pressing down a plurality of portions of the edge portion on the Y-direction side of the housing hole 16 of the shell 10 such as to project to inside the housing hole 16. The plurality of swaged portions 17 can be omitted.

The shell 10 may further include a plurality of legs 18. The legs 18 extend from the shell 10 in the Y direction. The legs 18 are received in, and connected to, respective through-hole grounding electrodes of a circuit board (not illustrated). Each of the legs 18 may extend in the X direction, the X′ direction, the Z direction, or the Z′ direction. In this case, the legs 18 may be connected to respective surface grounding electrodes of a circuit board. The legs 18 can be omitted.

The hybrid connector C2 further includes at least one first terminal 30a and at least one second terminal 30b.

The hybrid connector C2 further includes a body 20. The body 20 is constituted by an insulating material, e.g., an insulating resin or the like. The body 20 includes a base 21, a first projection 22a, a second projection 22b, at least one first retaining hole 23a, and at least one second retaining hole 23b.

The base 21 includes a portion in the Y-Y′ direction having an outer shape and outer dimensions in a cross section along the Z-Z′ and X-X′ directions that correspond to a shape and dimensions, respectively, in a cross section along the Z-Z′ and X-X′ directions of the housing hole 16 of the shell 10. The base 21 fits in the housing hole 16 of the shell 10 from the Y-direction side and abuts the bounding wall 12 of the shell 10 from the Y-direction side. Where the plurality of swaged portions 17 of the shell 10 is provided, the swaged portions 17 abut the base 21 from the Y-direction side. That is, the base 21 is securely sandwiched between the bounding wall 12 of the shell 10 and the swaged portions 17. The swaged portions 17 can be omitted.

The first projection 22a is generally shaped like a cylinder or polygonal prism, extends from the base 21 in the Y′ direction, and is disposed in the first connecting hole 11a of the shell 10. The first projection 22a has a dimension in the Y-Y′ direction that is smaller than a dimension in the Y-Y′ direction of the first connecting hole 11a. The first projection 22a has an outer shape and outer dimensions in a cross section along the Z-Z′ and X-X′ directions that correspond to an inner shape and inner dimensions, respectively, in a cross section along the Z-Z′ and X-X′ directions of the protruding portion 210a of the first connecting portion 200a of the hybrid connector C1. With the protruding portion 210a of the first connecting portion 200a received in the first connecting hole 11a, the first projection 22a fits in the protruding portion 210a of the first connecting portion 200a.

The at least one first retaining hole 23a may be a single hole or a plurality of holes in accordance with the number of the at least one first terminal 300a of the hybrid connector C1. The first retaining hole or holes 23a extend through the base 21 and the first projection 22a in the Y-Y′ direction.

The second projection 22b is generally shaped like a cylinder or polygonal prism, extends from the base 21 in the Y′ direction, is disposed on the Z-direction side, and in spaced relation to, relative to the first projection 22a, and is disposed in the second connecting hole 11b of the shell 10. The second projection 22b has a dimension in the Y-Y′ direction that is smaller than a dimension in the Y-Y′ direction of the second connecting hole 11b. Where the second connecting portion 200b of the hybrid connector C1 is provided with the connecting hole 240b, the second projection 22b has an outer shape and outer dimensions in a cross section along the Z-Z′ and X-X′ directions that correspond to a shape and dimensions, respectively, in a cross section along the Z-Z′ and X-X′ directions of the connecting hole 240b. With the second connecting portion 200b received in the second connecting hole 11b, the second projection 22b fits in the connecting hole 240b of the second connecting portion 200b. Where the connecting hole 240b is not provided, with the second connecting portion 200b received in the second connecting hole 11b, the second projection 22b abuts or faces the second connecting portion 200b.

The at least one second retaining hole 23b may be a single hole or a plurality of holes in accordance with the number of the at least one second terminal 300b of the hybrid connector C1. The first retaining hole or holes 23a extend through the base 21 and the first projection 22a in the Y-Y′ direction.

The at least one first terminal 30a may be a single terminal or a plurality of terminals in accordance with the number of the at least one first terminal 300a of the hybrid connector C1. In accordance with the at least one first terminal 300a described above as the single first terminal 300a, the at least one first terminal 30a and the at least one first retaining hole 23a of the body 20 will also be described as a single first terminal 30a and the single first retaining hole 23a. Also where the at least one first terminal 30a and the at least one first retaining hole 23a of the body 20 are respectively a plurality of first terminals 30a and a plurality of first retaining holes 23a, they may be configured similarly to what is described below.

The first terminal 30a is constituted by an electrically conductive material, such as a metal plate, and includes a first contact portion 31a, a first body portion 32a, and a first tail 33a.

The first body portion 32a is a portion between the first contact portion 31a and the first tail 33a of the first terminal 30a. For example, the first body portion 32a is constituted by a plate (see FIGS. 5C, 6A, 6B, 7A, and 7B), a rod, a generally tubular member (not illustrated), a generally U-shaped plate, or the like extending in the Y-Y′ direction. The first body portion 32a is securely housed in the first retaining hole 23a of the body 20.

The first contact portion 31a is constituted by a rod (see FIGS. 5C, 6A, 6B, 7A, and 7B), a plate (not illustrated), a tube (not illustrated), a pair of beams, or the like extending in the Y direction from an end on the Y-direction side of the first body portion 32a. The first contact portion 31a protrudes from the first retaining hole 23a of the body 20 in the Y′ direction and is disposed in the first connecting hole 11a of the shell 10. With the protruding portion 210a of the first connecting portion 200a of the hybrid connector C1 received in the first connecting hole 11a of the shell 10, the first contact portion 31a is received in the protruding portion 210a of the first connecting portion 200a of the hybrid connector C1 and is in contact with the first contact portion 310a of the first terminal 300a of the hybrid connector C1.

The first tail 33a is constituted by a rod (see FIGS. 5C, 6A, 6B, 7A, and 7B) or a flat plate (not illustrated) extending from the first body portion 32a in the Y′ direction. The first tail 33a protrudes from the first retaining hole 23a of the body 20 in the Y direction. The first tail 33a is received in, and connected to, a first through-hole electrode of a circuit board (not illustrated). The first tail 33a may be located on the Y′-direction side relative to the first body portion 32a, bent in the X, X′, or the Z′ direction, and connected to a first surface electrode of a circuit board.

The first terminal 30a may be disposed such that an imaginary line (not illustrated) extending in the Y-Y′ direction through the center of the first terminal 30a substantially coincides with the central axis of the first connecting hole 11a. Thus the first terminal 30a and the bounding wall 12, the first wall 11a1, the second wall 11a2, and the third wall 11a3 of the first connecting portion 200a may form a coaxial structure.

The at least one second terminal 30b is a single terminal (not illustrated) or a plurality of terminals (see FIGS. 5B, 5C, 6C, and 7A to 7C) in accordance with the number of the at least one second terminals 300b of the hybrid connector C1.

For convenience of description, the at least one second terminal 30b may also be hereinafter referred to as “the or each second terminal 30b”. Where a single second terminal 30b is provided, “the second terminal 30b” of the “the or each second terminal 30b” means the single second terminal 30b, and where a plurality of second terminals 30b is provided, “each second terminal 30b” of “the or each second terminal 30b” means each of the second terminals 30b.

The or each second terminal 30b is constituted by an electrically conductive material, such as a metal plate, and includes a second contact portion 31b, a second body portion 32b, and a second tail 33b.

The second body portion 32b is a portion between the second contact portion 31b and the second tail 33b of the or each second terminal 30b, for example. For example, the second body portion 32b is constituted by includes a plate (see FIGS. 5B and 5C, 6C, and 7A to 7C), a rod, a generally tubular member (not illustrated), a generally U-shaped plate, or the like extending in the Y-Y′ direction. The second body portion 32b is retained in the corresponding second retaining hole 23b of the base 21.

The second contact portion 31b is constituted by a rod (see FIGS. 5B and 5C, 6C, and 7A to 7C), a plate (not illustrated), a tube (not illustrated), a pair of beams, or the like extending in the Y direction from the end on the Y-direction side of the second body portion 32b. The second contact portion 31b protrudes in the Y′ direction from the corresponding second retaining hole 23b of the base 21. With the second connecting portion 200b of the hybrid connector C1 received in the second connecting hole 11b of the shell 10, the second contact portion 31b is received in the corresponding terminal housing portion 210b of the second connecting portion 200b of the hybrid connector C1 and in contact with the second contact portion 310b of the corresponding second terminal 300b of the hybrid connector C1.

The second tail 33b is constituted by a rod (see FIGS. 5B and 5C, 6C, and 7A to 7C) or a flat plate (not illustrated) extending from the second body portion 32b in the Y′ direction. The second tail 33b protrudes in the Y direction from the corresponding second retaining hole 23b of the base 21. The second tail 33b is received in, and connected to, a corresponding second through-hole electrode of the circuit board (not illustrated). The second tail 33b may be located on the Y′-direction side relative to the second body portion 32b, bent in the X, X′, or Z direction, and connected to a corresponding second surface electrode of the circuit board.

The hybrid connector C2 may further include a ground terminal 40. The ground terminal 40 includes a first ring 41, a second ring 42, and a plurality of contact springs 43. The first ring 41 and the second ring 42 are C-shaped or circular-ring shaped metal plates configured to be reduced in diameter when elastically deformed, and are arranged in spaced relation to each other in the Y-Y′ direction. The plurality of contact springs 43 are provided between the first ring 41 and the second ring 42 and arranged in spaced relation to each other along the circumferential direction of the first ring 41. Each of the contact springs 43 is curved in an arc shape such that an intermediate portion thereof projects toward an imaginary line extending in the Y-Y′ direction through the centers of the first ring 41 and the second ring 42. Where the shell 10 is provided with the single or at least four steps 11a4, the ground terminal 40 is housed in a space defined between the single or at least four steps 11a4 and the base 21 of the body 20 in the space on the Y-direction side of the first connecting hole 11a. Where the shell 10 is not provided with the single or at least four steps 11a4, the ground terminal 40 is housed in the first connecting hole 11a. In either case, the first ring 41 and the second ring 42 of the ground terminal 40 are in elastic contact and electrical connection with the bounding wall 12, the first wall 11a1, the second wall 11a2, and the third wall 11a3 of the first connecting hole 11a, and the plurality of contact springs 43 of the ground terminal 40 surround the first contact portion 310a of the first terminal 300a. With the protruding portion 210a of the first connecting portion 200a of the hybrid connector C1 received in the first connecting hole 11a of the shell 10, the plurality of contact springs 43 of the ground terminal 40 is in contact with the protruding portion 210a of the first connecting portion 200a.

The ground terminal 40 can be omitted. In this case, with the protruding portion 210a of the first connecting portion 200a of the hybrid connector C1 received in the first connecting hole 11a of the shell 10, the first connecting portion 200a may be in contact with the bounding wall 12, the first wall 11a1, the second wall 11a2, and the third wall 11a3 of the first connecting hole 11a of the shell 10.

A method for manufacturing the hybrid connector C2 will now be described. The first terminal 30a is prepared. The body 20 is prepared. The first contact portion 31a of the first terminal 30a is inserted into the first retaining hole 23a of the body 20 from the Y-direction side, and the first body portion 32a of the first terminal 30a is retained in the first retaining hole 23a of the body 20. Thus the first contact portion 31a of the first terminal 30a protrudes from the first retaining hole 23a of the body 20 in the Y′ direction, and the first tail 33a of the first terminal 30a protrudes from the first retaining hole 23a of the body 20 in the Y direction. The single or plurality of second terminals 30b is prepared. The second contact portion 31b of the or each second terminal 30b is inserted into the corresponding second retaining hole 23b of the body 20 from the Y-direction side, and the second body portion 32b of the or each second terminal 30b is retained in the corresponding second retaining hole 23b of the body 20. The step of assembling the single or plurality of second terminals 30b into the body 20 may be performed before, or simultaneously with, the step of assembling the first terminal 30a into the body 20. The ground terminal 40 is also prepared. The shell 10 is prepared. The shell 10 is not provided with the plurality of swaged portions 17. In a state where the first ring 41 and the second ring 42 of the ground terminal 40 are reduced in diameter, the ground terminal 40 is inserted into the first connecting hole 11a of the shell 10 from the Y-direction side Thereafter, the diameter-reduced state of the first ring 41 and the second ring 42 of the ground terminal 40 are released, so that the first ring 41 and the second ring 42 of the ground terminal 40 are brought into elastic contact with and electrical connection with the bounding wall 12, the first wall 11a1, the second wall 11a2, and the third wall 11a3 of the first connecting hole 11a. Thereafter, the base 21 of the body 20 is fitted into the housing hole 16 of the shell 10 from the Y-direction side. At this time, the base 21 of the body 20 is brought into abutment with the bounding wall 12 of the shell 10, the first projection 22a and the second projection 22b of the body 20 are inserted into the first connecting hole 11a and the second connecting hole 11b, respectively, of the shell 10 from the Y-direction side, the first contact portion 31a of the first terminal 30a is inserted into the first connecting hole 11a of the shell 10 from the Y-direction side, and the second contact portion 31b of the or each second terminal 30b is inserted into the corresponding second connecting hole 11b of the shell 10 from the Y-direction side. On the other hand, the first tail 33a of the first terminal 30a and the second tail 33b of the or each second terminal 30b protrude in the Y direction relative to the shell 10. Thereafter, the plurality of portions of the peripheral edge portion on the Y-direction side of the housing hole 16 of the shell 10 are pressed down to form the plurality of swaged portions 17 projecting to inside the housing hole 16. The thus formed swaged portions 17 abut the base 21 from the Y-direction side. In this way, the hybrid connector C2 is manufactured.

Where neither the first projection 22a nor the second projection 22b of the body 20 are provided, the above-described step of inserting the first projection 22a and the second projection 22b is omitted. Where the ground terminal 40 is not provided, the above-described step of attaching the ground terminal 40 is omitted. Where the swaged portions 17 of the shell 10 are not provided, the step of forming the swaged portions 17 is omitted.

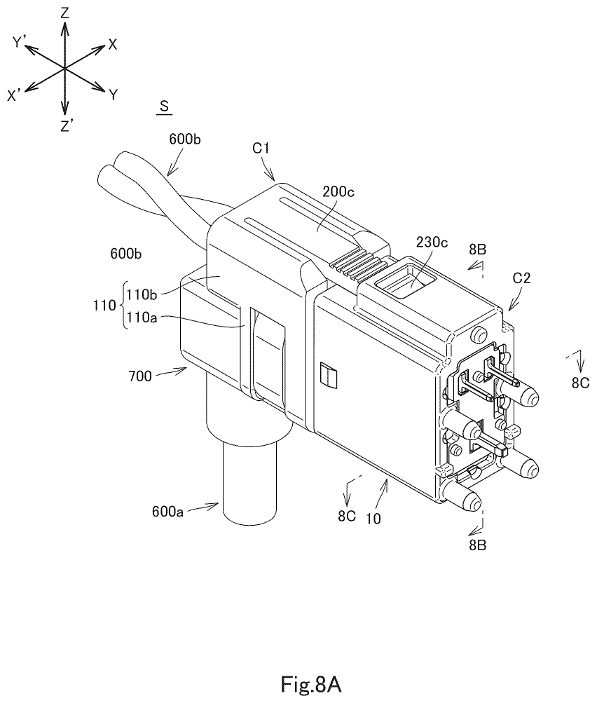

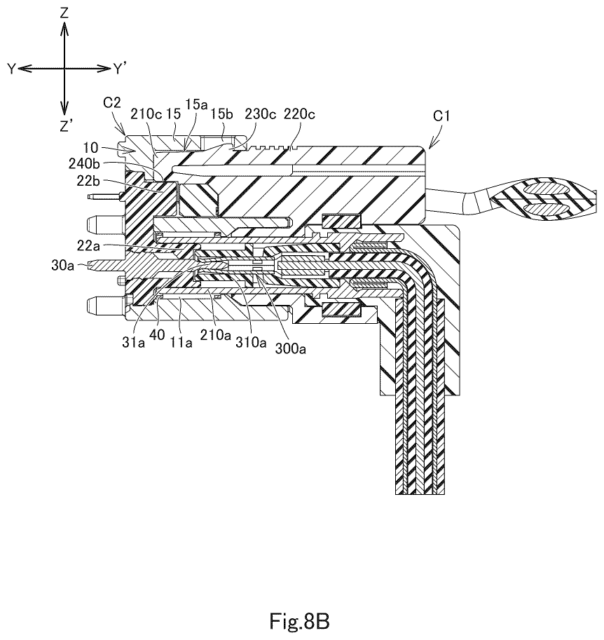

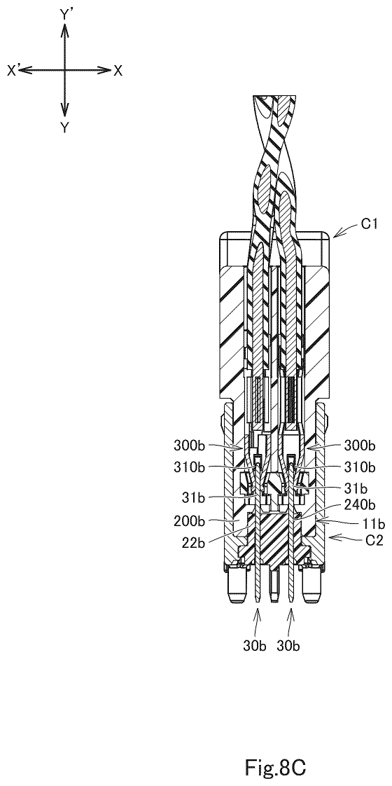

A connection structure S (combination) of the hybrid connector C1 and the hybrid connector C2 will be described with reference to FIGS. 8A to 8C. FIGS. 8A to 8C illustrate the connection structure S of the first embodiment. FIGS. 8A to 8C also show the Y-Y′ direction, FIGS. 8A and 8B also illustrate the Z-Z′ direction, and FIGS. 8A and 8C also illustrate the X-X′ direction.

The connection structure S includes the hybrid connector C1 and the hybrid connector C2.

The hybrid connector C1 and the hybrid connector C2 are brought into the directly facing state described above and then brought relatively close to each other in the Y-Y′ direction. The first connecting portion 200a and the second connecting portion 200b of the hybrid connector C1 are thereby inserted into the first connecting hole 11a and the second connecting hole 11b, respectively, of the shell 10 of the hybrid connector C2, the or each anti-misinsertion projection 220b of the hybrid connector C1 is inserted into the corresponding anti-misinsertion recess 14 of the hybrid connector C2, and the bounding wall 12 of the hybrid connector C2 is inserted into the gap G of the hybrid connector C1. With the first connecting portion 200a and the second connecting portion 200b of the hybrid connector C1 inserted into the first connecting hole 11a and the second connecting hole 11b, respectively, of the shell 10 of the hybrid connector C2, the or each anti-misinsertion projection 220b of the hybrid connector C1 inserted into the corresponding anti-misinsertion recess 14 of the hybrid connector C2, and the bounding wall 12 of the hybrid connector C2 inserted into the gap G of the hybrid connector C1 (in a state where these insertions are complete), the first projection 22a of the body 20 of the hybrid connector C2 fits inside the first connecting portion 200a of the hybrid connector C1, and the second projection 22b of the body 20 of the hybrid connector C2 fits in the connecting hole 240b of the second connecting portion 200b of the hybrid connector C1. The first contact portion 310a of the first terminal 300a of the hybrid connector C1 is brought into contact with the first contact portion 31a of the first terminal 30a of the hybrid connector C2, and the second contact portion 310b of the or each second terminal 300b of the hybrid connector C1 is brought into contact with the second contact portion 31b of the corresponding second terminal 30b of the hybrid connector C2. Thus the hybrid connector C1 and the hybrid connector C2 are connected together to form the connection structure S.

Where the first projection 22a of the hybrid connector C2 is not provided, the above-described step of fitting the first projection 22a is omitted. Where neither the connecting hole 240b of the second connecting portion 200b of the hybrid connector C1 nor the second projection 22b of the hybrid connector C2 are provided, the above-described step of fitting the second projection 22b into the connecting hole 240b is omitted.

As used hereinafter the term “connected state” means a state where the hybrid connector C1 and the hybrid connector C2 are connected together, and the term “connection process” means a process of connecting the hybrid connector C1 and the hybrid connector C2 together.

Where the hybrid connector C1 is provided with the tube 120 and the hybrid connector C2 is provided with the single or at least four steps 11a4, in the connected state, the tube 120 of the hybrid connector C1 fits in the space on the Y′-direction side of the first connecting hole 11a of the hybrid connector C2 and abuts the single or at least four steps 11a4 from the Y′-direction side, and the protruding portion 210a of the first connecting portion 200a of the hybrid connector C1 passes through the single step 11a4, or through between the at least four steps 11a4, and is in contact with the single or at least four steps 11a4 or faces the single or at least four steps 11a4 with a slight gap therebetween.

Where the hybrid connector C1 is provided with the tube 120 but the hybrid connector C2 is not provided with the single or at least four steps 11a4, in the connected state, the tube 120 of the hybrid connector C1 fits in the first connecting hole 11a of the hybrid connector C2, and the protruding portion 210a of the first connecting portion 200a of the hybrid connector C1 is disposed in the first connecting hole 11a of the hybrid connector C2.

Where the hybrid connector C1 is not provided with the tube 120 but the hybrid connector C2 is provided with the single or at least four steps 11a4, in the connected state, the protruding portion 210a of the first connecting portion 200a of the hybrid connector C1 passes through the single step 11a4, or through between the at least four steps 11a4, and is in contact with the single or at least four steps 11a4 or faces the single or at least four steps 11a4 with a slight gap therebetween.

Where the at least one first keying projection 130 of the hybrid connector C1 is provided and the at least one first keying recess 13 of the hybrid connector C2 is provided, in the connected state, the or each first keying projection 130 of the hybrid connector C1 is received in the corresponding first keying recess 13 of the hybrid connector C2.

Where the at least one second keying projection of the hybrid connector C1 is provided and the at least one second keying recess of the hybrid connector C2 is provided, in the connected state, the or each second keying projection of the hybrid connector C1 is received in the corresponding second keying recess of the hybrid connector C2.

Where the hybrid connector C1 is provided with the lock portion 200c and the hybrid connector C2 is provided with the lock portion 15, in the connection process, the proximal portion 210c, the arm 220c, and the lock projection 230c of the lock portion 200c of the hybrid connector C1 are inserted into the guide hole 15a of the lock portion 15 of the hybrid connector C2. The lock portion 200c of the hybrid connector C1 is inserted into the guide hole 15a of the lock portion 15 of the hybrid connector C2 from the Y′-direction side, and the lock projection 230c of the lock portion 200c of the hybrid connector C1 is pressed by the portion on the Y-direction side of the guide hole 15a of the lock portion 15 of the hybrid connector C2, so that the arm 220c of the lock portion 200c of the hybrid connector C1 is elastically deformed to the Z′-direction side. In the shift from the connection process to the connected state, the lock projection 230c of the lock portion 200c of the hybrid connector C1 moves over the portion on the Y-direction side of the guide hole 15a of the lock portion 15 of the hybrid connector C2 and is fitted into the lock hole 15b of the lock portion 15 of the hybrid connector C2. As a result, the connected state is maintained.

Where the hybrid connector C2 is provided with the ground terminal 40, in the connection process, the plurality of contact springs 43 of the ground terminal 40 of the hybrid connector C2 come into elastic contact with the protruding portion 210a of the first connecting portion 200a of the hybrid connector C1 before the first contact portion 310a of the first terminal 300a of the hybrid connector C1 comes into contact with the first contact portion 31a of the first terminal 30a of the hybrid connector C2, and before the second contact portion 310b of the or each second terminal 300b of the hybrid connector C1 comes into contact with the second contact portion 31b of the corresponding second terminal 30b of the hybrid connector C2. Also maintained in the connected state is the state where the plurality of contact springs 43 of the ground terminal 40 of the hybrid connector C2 are in elastic contact with the protruding portion 210a of the first connecting portion 200a of the hybrid connector C1 and the shell 10 of the hybrid connector C2 is electrically connected to the first connecting portion 200a of the hybrid connector C1 via the ground terminal 40.

Where the hybrid connector C2 is not provided with the ground terminal 40, in the connection process, the protruding portion 210a of the first connecting portion 200a of the hybrid connector C1 comes into contact with the bounding wall 12, the first wall 11a1, the second wall 11a2, and the third wall 11a3 of the first connecting hole 11a of the hybrid connector C2 before the first contact portion 310a of the first terminal 300a of the hybrid connector C1 comes into contact with the first contact portion 31a of the first terminal 30a of the hybrid connector C2, and before the second contact portion 310b of the or each second terminal 300b of the hybrid connector C1 comes into contact with the second contact portion 31b of the corresponding second terminal 30b of the hybrid connector C2.

Misinsertion between the hybrid connector C1 and the hybrid connector C2 is prevented in the following manners.

When the hybrid connector C1 and the hybrid connector C2 are in the first non-directly facing state, the hybrid connector C1 is brought relatively close to the hybrid connector C2 in the Y-Y′ direction. The first connecting portion 200a of the hybrid connector C1 and/or the at least one anti-misinsertion projection 220b is thereby brought into abutment with the bounding wall 12 of the hybrid connector C2. In this way, it is possible to prevent misinsertion between the hybrid connector C1 and the hybrid connector C2.

Where the single or at least four steps 11a4 in the first connecting hole 11a of the hybrid connector C2 are provided, and at least one of the above-described linear distances d9, d10 or d11 of the hybrid connector C2 is smaller than the shortest linear distance d5 of the hybrid connector C1, when the hybrid connector C1 and the hybrid connector C2 are in the second, third, or fourth non-directly facing state, the hybrid connector C1 is brought relatively close to the hybrid connector C2 in the Y-Y′ direction with the protruding portion 210a of the first connecting portion 200a of the hybrid connector C1 eccentrically located toward the first wall 11a1, the second wall 11a2, or the third wall 11a3 of the first connecting hole 11a of the hybrid connector C2. As a result, the at least one anti-misinsertion projection 220b and/or the first connecting portion 200a of the hybrid connector C1 is not brought into abutment with the first wall 11a1, the second wall 11a2, or the third wall 11a3 of the hybrid connector C2, but instead the protruding portion 210a of the first connecting portion 200a of the hybrid connector C1 is partly received into the first connecting hole 11a of the hybrid connector C2, the first wall 11a1, the second wall 11a2, or the third wall 11a3 of the first connecting hole 11a of the hybrid connector C2 is partly received into the gap G of the hybrid connector C1, and the protruding portion 210a of the first connecting portion 200a of the hybrid connector C1 is brought into abutment with the single or at least four steps 11a4 in the first connecting hole 11a of the hybrid connector C2. In this way, it is possible to prevent misinsertion between the hybrid connector C1 and the hybrid connector C2.

Where at least one of the above-described linear distances d9, d10 or d11 of the hybrid connector C2 is larger than the shortest linear distance d5 of the hybrid connector C1 (in any of these cases, the at least one step 11a4 may or may not be provided), when the hybrid connector C1 and the hybrid connector C2 are in the second, third, or fourth non-directly facing state, the hybrid connector C1 is brought relatively close to the hybrid connector C2 in the Y-Y′ direction, with the protruding portion 210a of the first connecting portion 200a of the hybrid connector C1 eccentrically located toward, or away from, the first wall 11a1, the second wall 11a2, or the third wall 11a3 of the first connecting hole 11a of the hybrid connector C2, or alternatively with the central axis of the first connecting portion 200a of the hybrid connector C1 substantially coinciding with the central axis of the first connecting hole 11a of the hybrid connector C2. The at least one anti-misinsertion projection 220b and/or the first connecting portion 200a of the hybrid connector C1 is thereby brought into abutment with the first wall 11a1, the second wall 11a2, or the third wall 11a3 of the hybrid connector C2. Also in this way, it is possible to prevent misinsertion between the hybrid connector C1 and the hybrid connector C2.

Where the dimension in the X-X′ direction of the second connecting portion 200b of the hybrid connector C1 is larger or smaller than the dimension in the Z-Z′ direction of the second connecting portion 200b of the hybrid connector C1, and the shape and the dimensions in the cross section along the Z-Z′ and X-X′ directions of the second connecting hole 11b of the hybrid connector C1 correspond to the outer shape and the outer dimensions, respectively, in the cross section along the Z-Z′ and X-X′ directions of the second connecting portion 200b of the hybrid connector C1, or alternatively where at least one of the above-described linear distances d12, d13 or d14 is larger than the shortest linear distance d5 of the hybrid connector C1, when the hybrid connector C1 and the hybrid connector C2 are in the fifth, sixth or seventh non-directly facing state, and the hybrid connector C1 and the hybrid connector C2 are brought relatively close to each other in the Y-Y′ direction. The at least one anti-misinsertion projection 220b and/or the second connecting portion 200b of the hybrid connector C1 is thereby brought into abutment with the fourth wall 11b1, the fifth wall 11b2 or the sixth wall 11b3 of the hybrid connector C2. Also in this case, it is possible to prevent misinsertion between the hybrid connector C1 and the hybrid connector C2.

Where the lock portion 15 of the hybrid connector C2 is provided, when the hybrid connector C1 and the hybrid connector C2 are in the eighth non-directly facing state, the hybrid connector C1 and the hybrid connector C2 are brought relatively close to each other in the Y-Y′ direction. The at least one anti-misinsertion projection 220b and/or the second connecting portion 200b of the hybrid connector C1 is thereby brought into abutment with an edge of the guide hole 15a of the lock portion 15 of the hybrid connector C2. Also in this case, it is possible to prevent misinsertion between the hybrid connector C1 and the hybrid connector C2.

Some non-limiting examples of use of the connection structure S are as follows. Where the hybrid connector C2 includes the plurality of second terminals 30b, the first terminal 300a, the first connecting portion 200a, and the first cable 600a of the hybrid connector C1, and the first terminal 30a, the shell 10, and the ground terminal 40 (if provided) of the hybrid connector C2 can be used as a coaxial transmission path for signal transmission, while the plurality of second terminals 300b and the plurality of second cables 600b of the hybrid connector C1 and the plurality of second terminals 30b of the hybrid connector C2 can be used as transmission paths for power supply. The coaxial transmission path for signal transmission may also be used for power supply by superimposing a power supply voltage on signals transmitted by the first terminal 300a and the inner conductor 640b of the first cable 600a of the hybrid connector C1, and the first terminal 30a of the hybrid connector C2. The at least one second terminal 300b and the at least one second cable 600b of the hybrid connector C1 and the at least one second terminal 30b of the hybrid connector C2 may be used as transmission paths for signal transmission, or alternatively used as transmission paths for signal transmission and also used to supply a voltage that is different from a power supply voltage to be superimposed on the transmitted signals.

The connection structure S as described above provides the following technical features and effects (1) to (5).

### Technical Feature and Effect (1)

The connection structure S including the above-described novel hybrid connector C1 is provided.

### Technical Feature and Effect (2)

The connection structure S is advantageously able to prevent misinsertion between the hybrid connector C1 and the hybrid connector C2 as described above.

### Technical Feature and Effect (3)

Where the hybrid connector C2 is provided with the ground terminal 40, in the connection process, the ground terminal 40 of the hybrid connector C2 come into elastic contact with the protruding portion 210a of the first connecting portion 200a of the hybrid connector C1 before the first terminal 300a of the hybrid connector C1 comes into contact with the first terminal 30a of the hybrid connector C2 and the or each second terminal 300b of the hybrid connector C1 comes into contact with the corresponding second terminal 30b of the hybrid connector C2. Therefore, overcurrent and/or noise is less likely to be generated when the first terminal 300a of the hybrid connector C1 comes into contact with the first terminal 30a of the hybrid connector C2 and the or each second terminal 300b of the hybrid connector C1 comes into contact with the corresponding second terminal 30b of the hybrid connector C2.

### Technical Feature and Effect (4)

Where the shell 10 of the hybrid connector C2 is provided with the plurality of swaged portions 17, when the body 20 of the hybrid connector C2 is housed inside the shell 10, the body 20 is less likely to be tilted or displaced. As a result, the body 20 of the hybrid connector C2 is easy to assemble into the shell 10. If the base 21 of the body 20 of the hybrid connector C2 was provided with a plurality of crush ribs, the insertion of the base 21 of the body 20 of the hybrid connector C2 into the housing hole 16 of the shell 10 would require press-fitting the base 21 of the body 20 of the hybrid connector C2 into the housing hole 16 of the shell 10 while pressing and crushing the crush ribs against the peripheral wall of the housing hole 16. The pressing force required for the press-fitting would act on the base 21 of the body 20 in an oblique direction including components of the Y′ direction and the Z, Z′, X, or X′ direction, increasing the possibility that the base 21 of the body 20 housed in the housing hole 16 of the shell 10 gets tilted or displaced. The press fitting would also require a large pressing force, making it difficult to assemble the base 21 of the body 20 into the housing hole 16 of the shell 10. On the other hand, in the hybrid connector C2, after the base 21 of the body 20 is fitted into the housing hole 16 of the shell 10, the swaged portions 17 are formed by pressing down a plurality of portions of the peripheral edge portion of the housing hole 16 of the shell 10. This configuration reduces the possibility that the body 20 of the hybrid connector C2 housed in the shell 10 gets tilted or displaced. The fitting of the base 21 into the housing hole 16 does not require a large pressing force as in the press-fitting described above, making it easy to assemble the body 20 into the shell 10.

### Technical Feature and Effect (5)

In the connected state, the protruding portion 210a of the first connecting portion 200a of the hybrid connector C1 is electrically connected to the shell 10 of the hybrid connector C1 indirectly via the ground terminal 40 or directly. This improves the EMC characteristic of the connection structure S.

### Second Embodiment

A hybrid connector C1′ (first hybrid connector) (not illustrated) according to a plurality of embodiments of the invention, including a second embodiment and a design modification thereof, will now be described. The hybrid connector C1′ is configured similarly to the hybrid connector C1, except that the first cable 600a, the second cable 600b, and the molded part 700 are omitted. The hybrid connector C1′ will be described focusing on the differences from the hybrid connector C1 and omitting overlapping descriptions.

The first tail 330a of the first terminal 300a of the hybrid connector C1′ is located on the Y′-direction side relative to the rear portion 230a of the first connecting portion 200a. The first tail 330a may extend in the Y-Y′ direction and protrude from the first body portion 110a of the housing 100 in the Y′ direction. Alternatively, the first tail 330a may be bent in the X, X′, or Z′ direction and protrude from the first body portion 110a of the housing 100 in the X, X′, or Z′ direction. In the former case, the first tail 330a is received in, and connected to, a first through-hole electrode of a circuit board (not illustrated). In the latter case, the first tail 330a is connected to a first surface electrode of a circuit board.

The second tail 330b of the or each second terminal 300b of the hybrid connector C1′ is located on the Y′-direction side relative to the second body portion 110b of the housing 100. The second tail 330b may extend in the Y-Y′ direction and protrude from the second body portion 110b of the housing 100 in the Y′ direction, or the second tail 330b may be bent in the X direction, the X′ direction, the Z direction, or the Z′ direction and protrude from the second body portion 110b of the housing 100 in the X direction, the X′ direction, or the Z direction. In the former case, the second tail 330b is inserted into and connected to a corresponding second through-hole electrode of the circuit board. In the latter case, the second tail 330b is connected to a corresponding second surface electrode of the circuit board. The cable retaining portion 340b of the or each second terminal 300b of the hybrid connector C1′ is omitted.

The rear portion 230a of the first connecting portion 200a of the hybrid connector C1′ is provided with a plurality of legs (not illustrated). Each leg may extend in the Y′ direction, or may extend in the X direction, the X′ direction, or the Z′ direction. In the former case, the legs are received in, and connected to, respective through-hole grounding electrodes of the circuit board. In the latter case, the legs are received in, and connected to, respective surface grounding electrodes of the circuit board.

the hybrid connector C1′ provides the same technical features and effects as the technical features and effects (1) to (5) of the hybrid connector C1.

A hybrid connector C2′ (second hybrid connector) (not illustrated) according to a plurality of embodiments of the invention, including a second embodiment and a design modification thereof, will now be described. The hybrid connector C2′ is configured similarly to the hybrid connector C2, except that the hybrid connector C2′ further includes at least one first cable (not illustrated) and at least one second cable. The hybrid connector C2′ will be described focusing on the differences from the hybrid connector C2 and omitting overlapping descriptions.

The at least one first cable of the hybrid connector C2′ may be a single cable or a plurality of cables in accordance with the number of the at least one first terminal 30a of the hybrid connector C2′. Since the at least one first terminal 30a is herein described as a single first terminal 30a, the at least one first cable will also be described as a single cable. Also where the at least one first cable is a plurality of first cables, it may be configured similarly to what is described below.

The first cable of the hybrid connector C2′ includes an outer insulator, an outer conductor, an inner insulator, and an inner conductor. The outer insulator, the outer conductor, the inner insulator, and the inner conductor of the first cable of the hybrid connector C2′ are configured similarly to the outer insulator 610a, the outer conductor 620a, the inner insulator 630a, and the inner conductor 640a of the first cable 600a of the hybrid connector C1.

The distal portion of the outer conductor of the first cable of the hybrid connector C2′ is connected to the shell 10 of the hybrid connector C2′. The distal portion of the inner conductor of the first cable of the hybrid connector C2′ is connected to the first tail 33a of the first terminal 30a of the hybrid connector C2′.

The at least one second cable of the hybrid connector C2′ may be a single cable or a plurality of cables in accordance with the number of the at least one second terminal 30b of the hybrid connector C2′.

For convenience of description, the at least one second cable of the hybrid connector C2′ may also be hereinafter referred to as “the or each second cable”. Where a single second cable is provided, “the second cable” of the “the or each second cable” means the single second cable, and where a plurality of second cables is provided, “each second cable” of “the or each second cable” means each of the second cables.

The or each second cable includes a sheath and a wire. The sheath and the wire of the or each second cable are configured similarly to the sheath 610b and the wire 620b of the second cable 600b of the hybrid connector C1. The distal portion of the wire is connected to the second tail 33b of the corresponding second terminal 30b.

A connection structure S′ (combination) of the hybrid connector C1′ and the hybrid connector C2′ will now be described. The connection structure S′ includes the hybrid connector C1′ and the hybrid connector C2′.

The hybrid connector C1′ and the hybrid connector C2′ are connected together in a similar manner to the hybrid connector C1 and the hybrid connector C2. In addition, it is advantageously possible to prevent misinsertion between the hybrid connector C1 and the hybrid connector C2 in similar manners to the hybrid connector C1 and the hybrid connector C2.

The connection structure S′ described above provides the same technical features and effects as the technical features and effects (1) to (5) of the connection structure S. It is possible to connect the hybrid connector C1 and the hybrid connector C2′ to form a connection structure S″ (combination), or alternatively connect the hybrid connector C1′ and the hybrid connector C2 to form a connection structure S″′ (combination). The connection structure S″ and the connection structure S″′ also provides the same technical features and effects as the technical features and effects (1) to (5) of the connection structure S.

The hybrid connectors and the connection structures (combinations) thereof are not limited to the above embodiments but may be modified in any manner within the scope of the claims. Some examples of modification will be described below.

The first connecting portion 200a of the hybrid connector C1 or C1′ may be constituted by an insulating material, e.g., an insulating resin or the like, and may be integral and contiguous with the end face on the Y-direction side of the body portion 110 of the housing 100 of the hybrid connector C1 or C1′. For example, the first connecting portion 200a may be configured similarly to the second connecting portion 200b of any of the above aspects. In this case, the body 400 of the hybrid connector C1 or C1′ may be omitted, and the single or plurality of first terminals 300a may be configured similarly to the single or plurality of second terminals 300b. In this case, the at least one first cable 600a of the hybrid connector C1 may also be configured similarly to the at least one second cable 600b and connected to the single or plurality of first terminals 300a as described above.

The second connecting portion 200b of the hybrid connector C1 or C1′ may be provided separately from the body portion 110, constituted by an electrically conductive material and/or an insulating material, and retained by the body portion 110 of the housing 100 of the hybrid connector C1 or C1′. For example, the second connecting portion 200b may be configured similarly to the first connecting portion 200a of any of the above aspects. In this case, the single or plurality of second terminals 300b may be configured similarly to the single or plurality of first terminals 300a and retained by a body constituted by an insulating material, and the body may be securely housed inside the second connecting portion 200b. In this case, the at least one second cable 600b of the hybrid connector C1 may also be configured similarly to the at least one first cable 600a and connected to the single or plurality of second terminals 300b as described above.

The at least one first terminal 300a of the hybrid connector C1 or C1′ may be modified in any manner as long as it is a terminal disposed inside the first connecting portion 200a of the hybrid connector C1 or C1′ of any of the above aspects and includes the first contact portion 310a disposed such as to be viewable from outside the first connecting portion 200a. The at least one first terminal 300a of any of the above aspects may be exposed or protruded from the first connecting portion 200a of any of the above aspects such as to be viewable from the Y-direction side.

The at least one second terminal 300b of the hybrid connector C1 or C1′ may be modified in any manner as long as it is a terminal disposed inside the second connecting portion 200b of the hybrid connector C1 or C1′ of any of the above aspects and includes the second contact portion 310b disposed such as to be viewable from outside the second connecting portion 200b. The at least one second terminal 300b of any of the above aspects may be exposed or protruded from the second connecting portion 200b of any of the above aspects such as to be viewable from the Y-direction side.

Where the at least one first terminal 300a of the hybrid connector C1 is a plurality of terminals, or alternatively where the at least one first terminal 30a of the hybrid connector C2′ is a plurality of terminals, the first cable of the hybrid connector C1 or C2′ may include the outer insulator 610a, the outer conductor 620a, a plurality of the inner insulators 630a, and a plurality of the inner conductors 640a. The plurality of inner insulators 630a is disposed inside the outer conductor 620a. The distal portions on the Y-direction side of the inner insulators 630a protrude from the outer conductor 620a in the Y direction. The distal portions of the inner conductors 640a are connected to the respective first terminals 300a or the respective first terminals 30a. In this case, the outer conductor may be omitted.

Where the at least one second terminal 300b of the hybrid connector C1 is a plurality of terminals, or alternatively where the at least one second terminal 30b of the hybrid connector C2′ is a plurality of terminals, the second cable of the hybrid connector C1 may include a plurality of the sheath 610b, a plurality of the wires 620b, an outer insulator (not illustrated), and an outer conductor (not illustrated). The outer insulator is a tubular jacket constituted by an insulating material. The outer conductor is a tube constituted by a conductor, such as a copper wire mesh, and is disposed inside the outer insulator. The outer conductor includes a distal portion on the Y-direction side protruding from the outer insulator in the Y direction. The plurality of sheath 610b is disposed inside the outer conductor. The distal portions on the Y-direction side of the plurality of sheath 610b protrude from the outer conductor in the Y direction. The distal portions of the wires 620b are connected to the respective second terminals 300b or the respective second terminals 30b. In this case, the outer conductor may be omitted.

The hybrid connector C1 or C1′ may include at least one third connecting portion in addition to the first connecting portion 200a and the second connecting portion 200b. The at least one third connecting portion is only required to protrude from the housing in the Y-Y′ direction and may have the same configuration as the first connecting portion 200a.

The hybrid connector C2 or C2′ may include at least one third connecting hole in addition to the first connecting hole 11a and the second connecting hole 11b. The at least one third connecting hole is only required to extend in the Y-Y′ direction and open in the Y′ direction and may have the same configuration as the first connecting hole 11a.

The first retaining hole 23a and the second retaining hole 23b of the body 20 of the hybrid connector C2 or C2′ can be omitted. In this case, the first body portion 32a of the at least one first terminal 30a and the second body portion 32b of the at least one second terminal 30b of the hybrid connector C2 or C2′ may be insert-molded in, and retained by, the body 20.

The first projection 22a and the second projection 22b of the body 20 of the hybrid connector C2 or C2′ of any of the above aspects can be omitted. In this case, the entire body 20 of the hybrid connector C2 or C2′ may, but is not required to, be securely housed in the housing hole 16 of the body 20 of the hybrid connector C2 or C2′.

The at least one first terminal 30a of the hybrid connector C2 or C2′ of any of the above aspects may be modified in any manner as long as it is retained by the body 20 of the hybrid connector C2 or C2′ of any of the above aspects and includes the first contact portion 31 a protruded or exposed from the body 20 into the first connecting hole 11a. The at least one second terminal 30b of the hybrid connector C2 or C2′ of any of the above aspects may be modified in any manner as long as it is retained by the body 20 of the hybrid connector C2 or C2′ of any of the above aspects and includes the second contact portion 31b protruding from the body 20 into the second connecting hole 11b.

A method for connecting a connector of an aspect of the invention will now be described. This method includes: preparing a body constituted by an insulating material and retaining at least one terminal in part; preparing a shell having electrical conductivity; housing the body into an housing hole of the shell from one side in a first direction, the housing hole opening to the one side in the first direction; and pressing a plurality of portions of a peripheral edge portion of the housing hole of the shell to form a plurality of swaged portions projecting to inside the housing hole, so that the plurality of swaged portions is brought into abutment with the body from the one side in the first direction. It should be understood that the method described above is not an invention dependent on the subject matter of the invention of the hybrid connectors and the connection structures described above, but is a separate and independent invention.

For example, the at least one terminal in the connector connection method may be at least one of the at least one first terminal 30a or the at least one second terminal 30b of the hybrid connector C2 or C2′, the body in the connector connection method may be the body 20 of the hybrid connector C2 or C2′, and the shell in the connector connection method may be the shell 10 of the hybrid connector C2 or C2′. The shell 10 may be provided with at least one of the first connecting hole 11a or the second connecting hole 11b communicating with the housing hole 16.

### REFERENCE SIGNS LIST

S: connection structure
   C1: hybrid connector
      100: housing; 110: body portion; 110a: first body portion; 110b: second body portion; 111a: first housing space; 111b: second housing space; 112a: first engaging hole; 120: tube; 121: first portion; 122: second portion; 130: first keying projection
      200a: first connecting portion
         210a: protruding portion; 211a: first portion; 212a: second portion; 220a: retainable portion; 230a: rear portion; 231a: abutment
      200b: second connecting portion
         210b: terminal housing portion; 220b: anti-misinsertion projection; 230b: second engaging hole; 240b: connecting hole
      200c: lock portion
         210c: proximal portion; 220c: arm; 230c: lock projection; 240c: arch
      300a: first terminal
         310a: first contact portion; 320a: first body portion; 330a: first tail
      300b: second terminal
         310b: second contact portion; 320b: second body portion; 330b: second tail; 340b: cable retaining portion
      400: body
         410: terminal housing portion; 411: first housing portion; 412: second housing portion; 413: retaining arm
      500a: retainer
         510a: engaging arm; 520a: coupling portion
      500b: retainer
         510b: engaging arm; 520b: coupling portion; 530b: partition
      600a: first cable; 600b: second cable
      700: molded part
      800: conductive ring
   C2: hybrid connector
      10: shell
         11a: first connecting hole; 11a1: first wall; 11a2: second wall; 11a3: third wall; 11a4: step; 11b: second connecting hole; 11b1: fourth wall; 11b2: fifth wall; 11b3: sixth wall; 12: bounding wall; 13: first keying recess; 14: anti-misinsertion recess; 15: lock portion; 15a: guide hole; 15b: lock hole; 16: housing hole; 17: swaged portion swage 18: leg
      20: body
         21: base; 22a: first projection; 22b: second projection; 23a: first retaining hole; 23b: second retaining hole
      30a: first terminal
         31a: first contact portion; 32a: first body portion; 33a: first tail
      30b: second terminal
         31b: second contact portion; 32b: second body portion; 33b: second tail
      40: ground terminal
         41: first ring; 42: second ring; 43: contact spring

1. A hybrid connector comprising:
a housing constituted by an insulating material;
a first connecting portion protruding from the housing to one side in a first direction;
at least one first terminal being disposed inside the first connecting portion, the or each first terminal including a first contact portion being disposed such as to be viewable from outside the first connecting portion;
a second connecting portion protruding from the housing to the one side in the first direction and being disposed on one side in a second direction relative to, and in spaced relation to, the first connecting portion, the second direction being substantially orthogonal to the first direction;
at least one second terminal being disposed inside the second connecting portion, the or each second terminal including a second contact portion being disposed such as to be viewable from outside the second connecting portion; and
at least one anti-misinsertion projection provided at the second connecting portion such as to project to the other side in the second direction, the at least one anti-misinsertion projection being disposed between the first connecting portion and the second connecting portion in the second direction,
wherein the first direction is a direction in which the first connecting portion projects.

2. The hybrid connector according to claim 1, wherein
the housing includes a body portion,
the body portion includes a first body portion and a second body portion,
the first connecting portion has electrical conductivity, is of a tubular shape extending in the first direction, and includes a protruding portion and a retainable portion,
the retainable portion of the first connecting portion is retained by the first body portion of the housing,
the protruding portion of the first connecting portion protrudes from the first body portion of the housing to the one side in the first direction,
the hybrid connector further comprises a body constituted by an insulating material, the body retaining the at least one first terminal in part and being securely housed in the first connecting portion,
the first contact portion of the or each first terminal is disposed inside the first connecting portion and exposed from inside of the first connecting portion such as to be viewable from the one side in the first direction relative to the first connecting portion,
the second connecting portion is constituted by an insulating material, protrudes from the second body portion of the housing to the one side in the first direction, and retains the at least one second terminal, and
the at least one anti-misinsertion projection is constituted by an insulating material and integral and contiguous with the second connecting portion.

3. The hybrid connector according to claim 1, wherein
the housing includes a body portion and a tube,
the body portion includes a first body portion and a second body portion,
the tube has a generally circular tubular shape, a generally polygonal tubular shape, a generally circular tubular shape that is partly cut away, or a generally polygonal tubular shape that is partly cut away, the tube extending from the first body portion to the one side in the first direction,
the first connecting portion has electrical conductivity, is of a tubular shape extending in the first direction, and includes a protruding portion and a retainable portion,
the retainable portion of the first connecting portion is securely received in the tube,
the protruding portion of the first connecting portion protrudes from the tube to the one side in the first direction,
the hybrid connector further comprises a body constituted by an insulating material, the body retaining the at least one first terminal in part and being securely housed in the first connecting portion,
the first contact portion of the or each first terminal is disposed inside the first connecting portion and exposed from inside of the first connecting portion such as to be viewable from the one side in the first direction relative to the first connecting portion,
the second connecting portion is constituted by an insulating material, protrudes from the second body portion of the housing to the one side in the first direction, and retains the at least one second terminal, and
the at least one anti-misinsertion projection is constituted by an insulating material and integral and contiguous with the second connecting portion.

4. The hybrid connector according to claim 2, wherein
the protruding portion of the first connecting portion includes:
a first portion located on the one side in the second direction relative to a central axis of the first connecting portion; and
at least one second portion located on one side or the other side in a third direction relative to the first portion and located on the other side in the second direction relative to the first portion, the third direction being substantially orthogonal to the first and second directions,
a linear distance in the second direction between the or each second portion and the second connecting portion is larger than a linear distance in the second direction between the first portion and the second connecting portion, and
the or each anti-misinsertion projection projects toward the or a corresponding second portion of the first connecting portion.

5. The hybrid connector according to claim 3, wherein
the protruding portion of the first connecting portion includes:
a first portion located on the one side in the second direction relative to a central axis of the first connecting portion; and
at least one second portion located on one side or the other side in a third direction relative to the first portion and located on the other side in the second direction relative to the first portion, the third direction being substantially orthogonal to the first and second directions,
a linear distance in the second direction between the or each second portion and the second connecting portion is larger than a linear distance in the second direction between the first portion and the second connecting portion, and
the or each anti-misinsertion projection projects toward the or a corresponding second portion of the first connecting portion.

6. The hybrid connector according to claim 3, wherein
the tube includes:
a first portion located on the one side in the second direction relative to a central axis of the first connecting portion; and
at least one second portion located on one side or the other side in a third direction relative to the first portion and located on the other side in the second direction relative to the first portion, the third direction being substantially orthogonal to the first and second directions,
a linear distance in the second direction between the or each second portion of the tube and the second connecting portion is larger than a linear distance in the second direction between the first portion of the tube and the second connecting portion, and
the or each anti-misinsertion projection projects toward the or a corresponding second portion of the tube.

7. The hybrid connector according to claim 5, wherein
the tube includes:
a first portion located on the one side in the second direction relative to a central axis of the first connecting portion; and
at least one second portion located on the one side or the other side in the third direction relative to the first portion and located on the other side in the second direction relative to the first portion,
a linear distance in the second direction between the or each second portion of the tube and the second connecting portion is larger than a linear distance in the second direction between the first portion of the tube and the second connecting portion, and
the or each anti-misinsertion projection projects toward the or a corresponding second portion of the tube.

8. The hybrid connector according to claim 2, further comprising a retainer constituted by an insulating material, wherein
the second connecting portion includes:
at least one terminal housing portion to house the second contact portion of the or each second terminal; and
a pair of engaging holes provided on one side and the other side, respectively, in a third direction relative to the at least one terminal housing portion, the third direction being substantially orthogonal to the first and second directions,
the retainer includes a pair of engaging arms, and the engaging arms of the retainer are hooked to the respective engaging holes, and
the at least one second terminal is retained by the retainer and the second connecting portion.

9. The hybrid connector according to claim 3, further comprising a retainer constituted by an insulating material, wherein
the second connecting portion includes:
at least one terminal housing portion to house the second contact portion of the or each second terminal; and
a pair of engaging holes provided on one side and the other side, respectively, in a third direction relative to the at least one terminal housing portion, the third direction being substantially orthogonal to the first and second directions,
the retainer includes a pair of engaging arms, and the engaging arms of the retainer are hooked to the respective engaging holes, and
the at least one second terminal is retained by the retainer and the second connecting portion.

10. The hybrid connector according to claim 2, further comprising a lock portion including:
a proximal portion rising from a distal portion on the one side in the first direction of the second connecting portion to the one side in the second direction,
an arm extending from the proximal portion to the other side in the first direction and being disposed on the one side in the second direction relative to, and in spaced relation to, the second connecting portion, and
a lock projection provided at the arm such as to project to the one side in the second direction,
wherein the lock portion has a dimension in the first direction that is equal to, or smaller than, a sum of a dimension in the first direction of the second connecting portion and a dimension in the first direction of the second body portion of the housing.

11. The hybrid connector according to claim 3, further comprising a lock portion including:
a proximal portion rising from a distal portion on the one side in the first direction of the second connecting portion to the one side in the second direction,
an arm extending from the proximal portion to the other side in the first direction and being disposed on the one side in the second direction relative to, and in spaced relation to, the second connecting portion, and
a lock projection provided at the arm such as to project to the one side in the second direction,
wherein the lock portion has a dimension in the first direction that is equal to, or smaller than, a sum of a dimension in the first direction of the second connecting portion and a dimension in the first direction of the second body portion of the housing.

12. A connection structure of hybrid connectors comprising:
a first hybrid connector being the hybrid connector according to claim 1; and
a second hybrid connector including:
a shell having electrical conductivity,
a body constituted by an insulating material,
at least one first terminal, and
at least one second terminal, wherein the shell includes:
a first connecting hole extending in the first direction and opening to other side in the first direction,
a second connecting hole extending in the first direction, opening to the other side in the first direction, and being disposed on the one side in the second direction relative to, and in spaced relation to, the first connecting hole,
a bounding wall being a wall between the first connecting hole and the second connecting hole,
at least one anti-misinsertion recess being provided in the bounding wall, extending from the second connecting hole to the other side in the second direction, opening to the other side in the first direction, and communicating with the second connecting hole, and
a housing hole being provided on the one side in the first direction relative to the first and second connecting holes, communicating with the first and second connecting holes, and opening to the one side in the first direction,
the body of the second hybrid connector is securely housed at least partly in the housing hole,
the at least one first terminal of the second hybrid connector is retained by the body of the second hybrid connector and includes a first contact portion protruding from the body into the first connecting hole,
the at least one second terminal of the second hybrid connector is retained by the body of the second hybrid connector and includes a second contact portion protruding from the body into the second connecting hole, and
in a state where the first connecting portion and the second connecting portion of the first hybrid connector are received in the first connecting hole and the second connecting hole, respectively, of the second hybrid connector, the or each anti-misinsertion projection of the first hybrid connector is received in the or a corresponding anti-misinsertion recess of the second hybrid connector, and the bounding wall of the second hybrid connector is received in a gap between the first connecting portion, and the second connecting portion and the at least one anti-misinsertion projection of the first hybrid connector, the first contact portion of the or each first terminal of the first hybrid connector is in contact with the first contact portion of the or a corresponding first terminal of the second hybrid connector, and the second contact portion of the or each second terminal of the first hybrid connector is in contact with the second contact portion of the or a corresponding second terminal of the second hybrid connector.

13. The connection structure according to claim 12, wherein
the shell of the second hybrid connector includes:
the bounding wall,
a first wall located on one side in a third direction relative to the first connecting hole, the third direction being substantially orthogonal to the first and second directions,
a second wall located on the other side in the third direction relative to the first connecting hole, and
a third wall located on the other side in the second direction relative to the first connecting hole,
the bounding wall, the first wall, the second wall, and the third wall define the first connecting hole,
the connection structure is configured such that, in a state where the first connecting portion and the second connecting portion of the first hybrid connector face the first connecting hole and the second connecting hole of the second hybrid connector, respectively, in the first direction, the or each anti-misinsertion projection of the first hybrid connector faces the or a corresponding anti-misinsertion recess of the second hybrid connector in the first direction, and the bounding wall of the second hybrid connector faces the gap of the first hybrid connector in the first direction, by bringing the first hybrid connector and the second hybrid connector relatively close to each other in the first direction, the first connecting portion and the second connecting portion of the first hybrid connector are received into the first connecting hole and the second connecting hole, respectively, of the second hybrid connector, the or each anti-misinsertion projection of the first hybrid connector is received into the or a corresponding anti-misinsertion recess of the second hybrid connector, and the bounding wall of the shell of the second hybrid connector is received into the gap of the first hybrid connector, and
the connection structure is configured such that, in a state where the first connecting portion of the first hybrid connector faces the first connecting hole of the second hybrid connector in the first direction, and the gap of the first hybrid connector faces the first wall, the second wall, or the third wall of the shell of the second hybrid connector in the first direction, by bringing the first hybrid connector and the second hybrid connector relatively close to each other in the first direction, the at least one anti-misinsertion projection and/or the first connecting portion of the first hybrid connector is brought into abutment with the first wall, the second wall, or the third wall of the shell of the second hybrid connector.

14. The connection structure according to claim 12, wherein
the shell of the second hybrid connector includes:
the bounding wall,
a first wall located on one side in a third direction relative to the first connecting hole, the third direction being substantially orthogonal to the first and second directions,
a second wall located on the other side in the third direction relative to the first connecting hole,
a third wall located on the other side in the second direction relative to the first connecting hole, and
at least one step being provided at at least one of the bounding wall, the first wall, the second wall, or the third wall and located inside the first connecting hole,
the bounding wall, the first wall, the second wall, and the third wall define the first connecting hole,
the connection structure is configured such that, in a state where the first connecting portion and the second connecting portion of the first hybrid connector face the first connecting hole and the second connecting hole of the second hybrid connector, respectively, in the first direction, the or each anti-misinsertion projection of the first hybrid connector faces the or a corresponding anti-misinsertion recess of the second hybrid connector in the first direction, and the bounding wall of the second hybrid connector faces the gap of the first hybrid connector in the first direction, by bringing the first hybrid connector and the second hybrid connector relatively close to each other in the first direction, the first connecting portion and the second connecting portion of the first hybrid connector are received into the first connecting hole and the second connecting hole, respectively, of the second hybrid connector, the or each anti-misinsertion projection of the first hybrid connector is received into the or a corresponding anti-misinsertion recess of the second hybrid connector, and the bounding wall of the shell of the second hybrid connector is received into the gap of the first hybrid connector, and
the connection structure is configured such that, in a state where the first connecting portion of the first hybrid connector faces the first connecting hole of the second hybrid connector in the first direction, and the gap of the first hybrid connector faces the first wall, the second wall, or the third wall of the shell of the second hybrid connector in the first direction, by bringing the first hybrid connector and the second hybrid connector relatively close to each other in the first direction, the first connecting portion of the first hybrid connector is partly received into the first connecting hole of the second hybrid connector, the first wall, the second wall, or the third wall of the shell of the second hybrid connector is partly received into the gap of the first hybrid connector, and the first connecting portion of the first hybrid connector is brought into abutment with the at least one step in the first connecting hole of the second hybrid connector.

15. The connection structure according to claim 12, wherein
the shell of the second hybrid connector includes:
the bounding wall,
a fourth wall located on one side in a third direction relative to the second connecting hole, the third direction being substantially orthogonal to the first and second directions,
a fifth wall located on the other side in the third direction relative to the second connecting hole, and
a sixth wall located on the one side in the second direction relative to the second connecting hole,
the bounding wall, the fourth wall, the fifth wall, and the sixth wall define the second connecting hole,
the connection structure is configured such that, in a state where the first connecting portion and the second connecting portion of the first hybrid connector face the first connecting hole and the second connecting hole of the second hybrid connector, respectively, in the first direction, the or each anti-misinsertion projection of the first hybrid connector faces the or a corresponding anti-misinsertion recess of the second hybrid connector in the first direction, and the bounding wall of the second hybrid connector faces the gap of the first hybrid connector in the first direction, by bringing the first hybrid connector and the second hybrid connector relatively close to each other in the first direction, the first connecting portion and the second connecting portion of the first hybrid connector are received into the first connecting hole and the second connecting hole, respectively, of the second hybrid connector, the or each anti-misinsertion projection of the first hybrid connector is received into the or a corresponding anti-misinsertion recess of the second hybrid connector, and the bounding wall of the shell of the second hybrid connector is received into the gap of the first hybrid connector, and
the connection structure is configured such that, in a state where the second connecting portion of the first hybrid connector faces the second connecting hole of the second hybrid connector in the first direction, and the gap of the first hybrid connector faces the fourth wall, the fifth wall, or the sixth wall of the shell of the second hybrid connector in the first direction, by bringing the first hybrid connector and the second hybrid connector relatively close to each other in the first direction, the at least one anti-misinsertion projection and/or the second connecting portion of the first hybrid connector is brought into abutment with the fourth wall, the fifth wall, or the sixth wall of the shell of the second hybrid connector.

16. The connection structure according to claim 12, wherein
the first hybrid connector further comprises a lock portion, the lock portion including:
a proximal portion rising from a distal portion on the one side in the first direction of the second connecting portion to the one side in the second direction,
an arm extending from the proximal portion to the other side in the first direction and being disposed on the one side in the second direction relative to, and in spaced relation to, the second connecting portion, and
a lock projection provided at the arm such as to project to the one side in the second direction,
the shell of the second hybrid connector includes:
the bounding wall,
a fourth wall located on one side in a third direction relative to the second connecting hole, the third direction being substantially orthogonal to the first and second directions,
a fifth wall located on the other side in the third direction relative to the second connecting hole,
a sixth wall located on the one side in the second direction relative to the second connecting hole, and
a lock portion provided at the sixth wall such as to project to the one side in the third direction,
the bounding wall, the fourth wall, the fifth wall, and the sixth wall define the second connecting hole,
the lock portion of the second hybrid connector is provided with a guide hole, the guide hole extending in the first direction, opening to the other side in the first direction, extending through the sixth wall, and communicating with the second connecting hole,
the lock portion of the second hybrid connector includes a wall on the one side in the second direction relative to the guide hole, and the wall is provided with a lock hole extending from the guide hole to the one side in the second direction and communicating with the guide hole,
the connection structure is configured such that, in a state where the first connecting portion and the second connecting portion of the first hybrid connector face the first connecting hole and the second connecting hole of the second hybrid connector, respectively, in the first direction, the or each anti-misinsertion projection of the first hybrid connector faces the or a corresponding anti-misinsertion recess of the second hybrid connector in the first direction, the bounding wall of the second hybrid connector faces the gap of the first hybrid connector in the first direction, and the lock portion of the first hybrid connector faces the guide hole of the lock portion of the second hybrid connector in the first direction, by bringing the first hybrid connector and the second hybrid connector relatively close to each other in the first direction, the first connecting portion and the second connecting portion of the first hybrid connector are received into the first connecting hole and the second connecting hole, respectively, of the second hybrid connector, the or each anti-misinsertion projection of the first hybrid connector is received into the or a corresponding anti-misinsertion recess of the second hybrid connector, the bounding wall of the shell of the second hybrid connector is received into the gap of the first hybrid connector, the lock portion of the first hybrid connector is received into the guide hole of the lock portion of the second hybrid connector, and then the lock projection of the lock portion of the first hybrid connector is fitted into the lock hole of the lock portion of the second hybrid connector, and
the connection structure is configured such that, in a state where the first connecting portion of the first hybrid connector faces the second connecting hole of the second hybrid connector in the first direction, and the second connecting portion of the first hybrid connector faces the lock portion of the second hybrid connector in the first direction, by bringing the first hybrid connector and the second hybrid connector relatively close to each other in the first direction, the second connecting portion and/or the at least one anti-misinsertion projection of the first hybrid connector is brought into abutment with an edge of the guide hole of the lock portion of the second hybrid connector.

17. The connection structure according to claim 12, wherein
the second hybrid connector further comprises a ground terminal disposed in the first connecting hole of the shell and electrically connected to the shell,
the first connecting portion of the first hybrid connector has electrical conductivity and is of a tubular shape extending in the first direction,
the first hybrid connector further comprises a body constituted by an insulating material, the body of the first hybrid connector retaining the at least one first terminal in part and being securely housed in the first connecting portion of the first hybrid connector,
the first contact portion of the or each first terminal of the first hybrid connector is disposed inside the first connecting portion of the first hybrid connector and exposed from inside of the first connecting portion such as to be viewable from the one side in the first direction relative to the first connecting portion, and
the connection structure is configured such that, when the first connecting portion and the second connecting portion of the first hybrid connector are received into the first connecting hole and the second connecting hole, respectively, of the second hybrid connector, the first connecting portion of the first hybrid connector comes into contact with the ground terminal of the second hybrid connector before the first contact portion of the or each first terminal of the first hybrid connector comes into contact with the first contact portion of the or a corresponding first terminal of the second hybrid connector, and before the second contact portion of the or each second terminal of the first hybrid connector comes into contact with the second contact portion of the or a corresponding second terminal of the second hybrid connector.
